(19) United States
(12) Patent Application Publication
(10) Pub. No.: US 2009/0278771 A1
(43) Pub. Date: Nov. 12, 2009

(54) EL display panel, electronic instrument and panel driving method

(75) Inventors: Tetsuro Yamamoto, Kanagawa (JP); Katsuhide Uchino, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/385,430

(22) Filed: Apr. 8, 2009

(30) Foreign Application Priority Data
May 8, 2008 (JP) 2008-121741

(51) Int. Cl. G09G 3/30

(52) U.S. Cl. 345/76

(57) ABSTRACT

Disclosed herein is an organic electro luminescence display panel provided with a pixel structure and a wiring structure which are adapted to an active matrix driving method; and driven by an electric potential asserted on each multi-consecutive-row bundle composed of adjacent power-supply lines, which are electrically tied to each other, each stretched in a horizontal direction and each used for supplying a driving current to an organic electro luminescence light emitting device employed in every pixel circuit of said organic electro luminescence display panel, to serve as an electric potential having two or more different magnitudes.

### BACKGROUND OF THE INVENTION

1. Field of the Invention

In general, the present invention explained in this invention specification relates to a driving technology for driving an organic EL (Electro Luminescence) display panel driven in accordance with control executed by adoption of an active matrix driving method. It is to be noted that the present invention proposed in this invention specification also has a mode of a driving method for driving the organic EL display panel and a mode of electronic instruments which each employ the organic EL display panel.

2. Description of the Related Art

FIG. 1 is a block diagram showing the general circuit configuration of an organic EL display panel 1 of an active matrix driving type. As shown in the block diagram of FIG. 1, the organic EL display panel 1 employs a pixel array section 3 as well as a write scan driver 5 and a horizontal selector 7, which are located in the peripheries of the pixel array section 3. Each of the write scan driver 5 and the horizontal selector 7 serves as a driving circuit for driving the pixel array section 3. It is to be noted that the pixel array section 3 includes pixel circuits each located at the intersection of one of scan lines DTL and one of write scan lines WSL.

By the way, an organic EL device employed in each of the pixel circuits is a light emitting device. The organic EL display panel 1 adopts a driving method for controlling the gradation of any particular one of the pixel circuits by adjusting the magnitude of a driving current flowing through the organic EL light emitting device employed in the particular pixel circuit. FIG. 2 is a circuit diagram showing the simplest configuration of a pixel circuit of this type and driving circuits each used for driving the pixel circuit. As shown in the circuit diagram, the pixel circuit includes a signal sampling transistor T1, a device driving transistor T2, a signal holding capacitor Cs and an organic EL light emitting device OLED.

It is to be noted that the signal sampling transistor T1 is a thin-film transistor for controlling an operation to store a video-signal electric potential Vsig corresponding to the gradation of a pixel circuit into the signal holding capacitor Cs employed in the pixel circuit. On the other hand, the device driving transistor T2 is a thin-film transistor for providing the organic EL light emitting device OLED with a driving current Ids having a magnitude determined by a gate-source voltage Vgs which corresponds to the video-signal electric potential Vsig stored in the signal holding capacitor Cs. In the invention specification, the driving current Ids is also referred to as a drain-source current Ids generated by the device driving transistor T2. The gate-source voltage Vgs is a voltage appearing between the gate and source electrodes of the device driving transistor T2. In the case of the typical pixel circuit shown in the diagram of FIG. 2, the signal sampling transistor T1 is a thin-film transistor of the N-channel type whereas the device driving transistor T2 is a thin-film transistor of the P-channel type.

In the case of the typical pixel circuit shown in the diagram of FIG. 2, the source electrode of the device driving transistor T2 is connected to a power-supply line for providing a fixed high-level power-supply electric potential Vcc. The device driving transistor T2 typically operates in a saturated region. That is to say, the device driving transistor T2 operates as a constant-current source for providing the organic EL light emitting device OLED with a driving current Ids having a magnitude determined by a gate-source voltage Vgs which corresponds to the video-signal electric potential Vsig stored in the signal holding capacitor Cs. The drain-source current Ids generated by the device driving transistor T2 is expressed by the following equation:

Ids=k*μ*(Vgs−Vth)²/2

By the way, reference notation u used in the equation given above denotes the mobility of majority carriers in the device driving transistor T2 whereas notation Vth denotes the threshold voltage of the device driving transistor T2. Reference notation k is expressed by the following equation:

k=(W/L)*Cox

In the equation given above, reference notation W denotes the gate width of the device driving transistor T2, reference notation L denotes the gate length of the device driving transistor T2 whereas reference notation Cox denotes the gate capacitance per unit area of the device driving transistor T2.

It is to be noted that, in the case of the pixel circuit having the configuration shown in the diagram of FIG. 2, the voltage appearing on the drain electrode of the device driving transistor T2 changes in accordance with variations shown in a diagram of FIG. 3 as the generally known variations of the I-V characteristic of the organic EL light emitting device OLED with the lapse of time. In the following description, the variations of the I-V characteristic of the organic EL light emitting device OLED with the lapse of time are referred to as time-aging variations of the I-V characteristic of the organic EL light emitting device OLED. Since the gate-source voltage Vgs appearing between the gate and source electrodes of the device driving transistor T2 is fixed, however, the magnitude of the drain-source current Ids flowing to the organic EL light emitting device OLED does not change with the lapse of time so that the luminance of light emitted by the organic EL light emitting device OLED can be kept at a constant value.

References each describing the organic EL display panel adopting the active matrix driving method are as follows: Japanese Patent Laid-open Nos. 2003-255856, 2003-271095, 2004-133240, 2004-029791 and 2004093682.

### SUMMARY OF THE INVENTION

By the way, depending on the type of the thin-film process, the circuit configuration shown in the circuit diagram of FIG. 2 may probably be unusable in some cases. That is to say, by carrying out the contemporary thin-film process, a thin-film transistor of the P-channel type may not be used in some cases. In such cases, the device driving transistor T2 has to be replaced by a thin-film transistor of the N-channel type.

FIG. 4 is a circuit diagram showing the configuration of a pixel circuit which employs a thin-film transistor of the N-channel type to serve as the device driving transistor T2 and driving circuits each used for driving the pixel circuit. In this configuration, the source electrode of the device driving transistor T2 is connected to the anode electrode of the organic EL light emitting device OLED. However, the pixel circuit having the configuration shown in the circuit diagram of FIG. 4 raises a problem that the gate-source voltage Vgs appearing between the gate and source electrodes of the device driving transistor T2 changes due to time-aging variations of the I-V characteristic of the organic EL light emitting device OLED. The changes of the gate-source voltage Vgs appearing between the gate and source electrodes of the device driving transistor T2 cause driving-current variations which undesirably result in variations of the luminance of light emitted by the organic EL light emitting device OLED.

In addition, the threshold voltage and mobility of the device driving transistor T2 employed in the pixel circuit also vary from pixel to pixel. The variations of the threshold voltage and mobility of the device driving transistor T2 employed in the pixel circuit appear as variations in driving-current magnitude from pixel to pixel. Thus, the luminance of light emitted by the organic EL light emitting device OLED employed in the pixel circuit also changes from pixel to pixel.

For the reasons described above, if a pixel circuit having the configuration shown in the circuit diagram of FIG. 4 is used, it is necessary to establish a driving method which is capable of giving a stable light emission characteristic independent of variations with the lapse of time and allows the organic EL display apparatus to be manufactured at a low cost.

In order to solve the problems described above, inventors of the present invention have innovated an organic EL display panel having a pixel structure and a wiring structure which are provided for an active matrix driving method. The organic EL display panel is driven by an electric potential asserted on each multi-consecutive-row bundle composed of adjacent power-supply lines, which are electrically tied to each other and each used for supplying a driving current to an organic EL light emitting device employed in every pixel circuit of said organic EL display panel, to serve as an electric potential having two or more different magnitudes. That is to say, the organic EL display panel has a wiring structure in which adjacent ones of the power-supply lines each stretched in a horizontal direction are electrically tied to each other in multi-consecutive-row bundles.

In the case of this circuit configuration, a power-supply electric potential having two different magnitudes is shared by a plurality of power-supply lines, which compose a multi-consecutive-row bundle cited above, as a signal common to the power-supply lines. Thus, the number of output stages of a driving circuit for asserting the signal common to the power-supply lines pertaining to the multi-consecutive-row bundle can be reduced to a fraction of the number of output stages for a case in which a power-supply line is desired for driving pixel circuits provided on each matrix row. The reduction of the number of output stages allows the size of the driving circuit and the driving frequency to be also decreased as well. As a result, a low-cost driving circuit can be adopted in the organic EL display panel.

In addition, it is desirable to provide a configuration which includes a power-supply line driving circuit lowering a power-supply electric potential appearing on a plurality of aforementioned power-supply lines tied to each other to form a multi-consecutive-row bundle cited above from a light emission electric potential to a light extinction electric potential at least once during a time period. The timing period exists between a rise of the power-supply electric potential from the light extinction electric potential to the light emission electric potential for the first time in a no-light emission period and the start of a light emission period of a power-supply line stretched in a horizontal direction to serve as the last power-supply line pertaining to the multi-consecutive-row bundle as a time period in a light emission cycle composed of the light emission period and the no-light emission period. By the way, it is desirable to provide a configuration in which the light emission cycle is one horizontal scan period. In this invention specification, the technical term ‘no-light emission’ means light extinction.

In addition, it is desirable to provide a configuration in which, during a no-light emission period for a power-supply line stretched in the horizontal direction to serve as a power-supply line pertaining to a multi-consecutive-row bundle, at least three electric potentials, i.e., the electric potential of a video signal, a reference electric potential for compensation for threshold-voltage variations of a device driving transistor for controlling the magnitude of a driving current flowing to an organic EL light emitting device employed in the same pixel circuit as the device driving transistor and an initially stored electric potential, are supplied to the gate electrode of the device driving transistor.

In the configuration described above, it is desirable to set the initially stored electric potential so that: the level of the initially stored electric potential is lower than the level of the reference electric potential for compensation for the threshold-voltage variations; and the difference between the level of the initially stored electric potential and the level of the light extinction electric potential is not greater than the threshold voltage of the device driving transistor.

In addition, in the configuration described above, it is desirable to supply the initially stored electric potential of the three electric potentials, which are to applied to the gate electrode of the device driving transistor, to the gate electrode at least with the timing of a last threshold-value compensation preparatory period common to all the power-supply lines stretched in the horizontal direction and tied to each other to form a multi-consecutive row bundle.

In addition, if a threshold-value compensation process is carried out by dividing the threshold-value compensation process into a plurality of threshold-value compensation sub-processes each carried out in a horizontal scan period, it is desirable to supply the initially stored electric potential to the gate electrode of the device driving transistor for controlling the magnitude of a driving current flowing to an organic EL light emitting device employed in same pixel circuit as the device driving transistor at least during all the threshold-value compensation sub-processes except the last threshold-value compensation sub-process immediately leading ahead of a signal writing process of supplying the electric potential of a video signal to the gate electrode of the device driving transistor.

In addition, it is desirable to provide a configuration in which the power-supply line driving circuit cited above provides an electric-potential lowering period to lower the power-supply electric potential appearing on a plurality of aforementioned power-supply lines tied to each other to form the multi-consecutive-row bundle from the light emission electric potential to the light extinction electric potential once for each of the power-supply lines tied to each other to form the multi-consecutive-row bundle between the start of a light emission period of the first power-supply line pertaining to the multi-consecutive row bundle and the end of a light emission period of the last power-supply line pertaining to the multi-consecutive row bundle.

In addition, it is desirable to provide the organic EL display panel with a configuration including a power-supply line driving circuit which lowers the power-supply electric potential appearing on a plurality of power-supply lines tied to each other to form the multi-consecutive-row bundle from the light emission electric potential to the light extinction electric potential at least once during a time period existing between the start of a threshold-voltage compensation period of a power-supply line stretched in the horizontal direction to serve as the first power-supply line of the multi-consecutive-row bundle and the end of a threshold-voltage compensation period of a power-supply line stretched in the horizontal direction to serve as the last power-supply line of the multi-consecutive-row bundle as a time period in a light emission cycle composed of a light emission period and a no-light emission period.

In addition, the inventors of the present invention have also innovated electronic instruments each employing the organic EL display panel having the configuration described above. To put it in detail, each of the electronic instruments employs the organic EL display panel having the configuration described above, a system control section for controlling the entire system of the electronic instrument and an operation input section for receiving operation inputs entered to the system control section.

In the inventions proposed by the inventors of the present invention, power-supply lines each used for supplying a driving current to the organic EL light emitting device employed in a pixel circuit are driven by applying two or more electric potentials to the power-supply lines in multi-consecutive-row bundles each consisting of a plurality of adjacent power-supply lines stretched in the horizontal direction and tied to each other. Thus, the number of output stages of the driving circuit for asserting a power-supply electric potential on each of the multi-consecutive-row bundles can be reduced to a fraction of the number of output stages for a case in which a power-supply line is desired for driving pixel circuits provided on each matrix row. The reduction of the number of output stages allows the cost of manufacturing the driving circuit to be also decreased as well. As a result, a low-cost driving circuit can be adopted in the organic EL display panel.

### BRIEF DESCRIPTION OF THE DRAWINGS

FIG. 1 is a block diagram showing a general circuit configuration of an organic EL display panel of an active matrix driving type;

FIG. 2 is a circuit diagram showing the simplest configuration of a pixel circuit and driving circuits each used for driving the pixel circuit;

FIG. 3 is a diagram to be referred to in explanation of a time aging phenomenon observed as changes of the I-V characteristic of an organic EL light emitting device;

FIG. 4 is a circuit diagram showing another configuration of the pixel circuit and driving circuits each used for driving the pixel circuit;

FIG. 5 is a diagram showing a typical external configuration of an organic EL display panel;

FIG. 6 is a block diagram showing a typical system configuration of the organic EL display panel according to a first embodiment;

FIG. 7 is a block diagram showing connections between pixel circuits each serving as the circuit of a sub-pixel and driving circuits each used for driving the pixel circuits in the first embodiment;

FIG. 8 is a diagram showing the internal configuration of a pixel circuit according to the first embodiment and driving circuits each used for driving the pixel circuit;

FIGS. 9A to 9E are a timing diagram showing a timing chart of every signal generated during a typical driving operation carried out by the pixel circuit shown in the diagram of FIG. 8;

FIG. 10 is a circuit diagram to be referred to in description of an operation carried out by a pixel circuit in a light emission state of the pixel circuit during a period t1 shown in the timing diagram of FIGS. 9A to 9E;

FIG. 11 is a circuit diagram to be referred to in description of an operation carried out by the pixel circuit in an operating state during a period t2 shown in the timing diagram of FIGS. 9A to 9E;

FIG. 12 is a circuit diagram to be referred to in description of an operation carried out by the pixel circuit in an operating state during a period t3 shown in the timing diagram of FIGS. 9A to 9E as a period allocated to a threshold-voltage compensation preparatory process;

FIG. 13 is a circuit diagram to be referred to in description of an operation carried out by the pixel circuit in an operating state during a period t4 shown in the timing diagram of FIGS. 9A to 9E as a period allocated to a threshold-voltage compensation process;

FIG. 14 is a diagram depicting a curve showing how the source electric potential Vs appearing on the source electrode of the device driving transistor T2 increases with the lapse of time during the period t4;

FIG. 15 is a circuit diagram to be referred to in description of an operation carried out by the pixel circuit in an operating state of a mobility compensation process and a signal storing process during a period t6 shown in the timing diagram of FIGS. 9A to 9E and a period t7 immediately lagging behind the period t6;

FIG. 16 is a diagram depicting curves showing how the source electric potential Vs appearing on the source electrode of the device driving transistor T2 increases with the lapse of time for 2 device driving transistors having different values of the mobility;

FIG. 17 is a circuit diagram to be referred to in description of an operation carried out by the pixel circuit in a light emission state of the pixel circuit during a period t8 shown in the timing diagram of FIGS. 9A to 9E;

FIGS. 18A and 18B are diagrams each showing a wiring structure of power-supply lines DSL;

FIG. 19 is a block diagram showing a typical system configuration of an organic EL display panel according to the second embodiment;

FIG. 20 is a block diagram showing connections between pixel circuits each serving as the circuit of a sub-pixel and driving circuits each used for driving the pixel circuits in the second embodiment;

FIGS. 21A to 21E are a timing diagram showing a timing chart of each signal generated in basic driving operations according to the second embodiment;

FIGS. 22A to 22E are a timing diagram showing a timing chart of each signal generated in improved driving operations according to the second embodiment;

FIG. 23 is a block diagram showing a typical system configuration of an organic EL display panel according to a third embodiment;

FIG. 24 is a block diagram showing connections between pixel circuits each serving as the circuit of a sub-pixel and driving circuits each used for driving the pixel circuits in the third embodiment;

FIGS. 25A to 25E are a timing diagram showing a timing chart of each signal generated in driving operations according to the third embodiment;

FIGS. 26A to 26E are a timing diagram showing time differences each measured as a difference in time between the end of a threshold-voltage compensation preparatory process and the start of a threshold-voltage compensation process as well as a relation between a timing to assert a high-level scan signal on each of the write scan lines WSL for the threshold-voltage compensation process and a timing to assert a video signal vsig on the data signal line DTL after the threshold-voltage compensation process in the third embodiment;

FIGS. 27A to 27E are a timing diagram showing that, it is not till the execution of the threshold-voltage compensation process for the third one of the three power-supply lines DSL pertaining to the three-consecutive-row bundle has been ended that the power-supply electric potential asserted on each of the power-supply line DSL pertaining to the three-consecutive-row bundle to serve as the driving voltage is sustained at the high-level power-supply electric potential Vcc in accordance with the third embodiment;

FIGS. 28A to 28E are a timing diagram showing that, in each of two consecutive horizontal scan periods immediately leading ahead of the end of the execution of the light emission process for the third one of the three power-supply lines DSL pertaining to the three-consecutive-row bundle, the power-supply electric potential asserted on each of the power-supply line DSL pertaining to the three-consecutive-row bundle to serve as the driving voltage is controlled to change to the low-level power-supply electric potential Vss in order to set the number of no-light emission periods within a light emission period at 2 which is a number uniform for write scan lines WSL associated with all the power-supply lines DSL pertaining to the three-consecutive-row bundle in accordance with the third embodiment;

FIG. 29 is a block diagram showing a typical system configuration of an organic EL display panel according to a fourth embodiment;

FIG. 30 is a block diagram showing connections between pixel circuits each serving as the circuit of a sub-pixel and driving circuits each used for driving the pixel circuits in the fourth embodiment;

FIGS. 31A to 31E are a timing diagram showing a timing chart of each signal generated in driving operations according to the fourth embodiment;

FIGS. 32A to 32E are a timing diagram showing that the power-supply electric potential asserted on the power-supply line DSL to serve as a driving voltage is sustained at the high-level power-supply electric potential Vcc as it is till the light emission process has been completed for every write scan line WSL associated with one of the power-supply lines DSL pertaining to the three-consecutive-row bundle in accordance with the fourth embodiment;

FIGS. 33A to 33E are a timing diagram showing a control method to set the number of no-light emission periods included in a light emission period at 2 for the write scan line WSL associated with the first one of the three adjacent power-supply lines DSL pertaining to the three-consecutive-row bundle, 1 for the write scan line WSL associated with the second one of the three adjacent power-supply lines DSL and 0 for the write scan line WSL associated with the third one of the three adjacent power-supply lines DSL in accordance with the fourth embodiment;

FIG. 34 is a block diagram showing a typical system configuration of an organic EL display panel according to a fifth embodiment;

FIG. 35 is a diagram showing the internal configuration of a pixel circuit according to the fifth embodiment and driving circuits each used for driving the pixel circuit;

FIGS. 36A to 36E are a timing diagram showing a timing chart of every signal generated during a typical driving operation carried out by the pixel circuit shown in the diagram of FIG. 35;

FIG. 37 is a circuit diagram to be referred to in description of an operation carried out by a pixel circuit in a light emission state of the pixel circuit during a period ti shown in the timing diagram of FIGS. 36A to 36E;

FIG. 38 is a circuit diagram to be referred to in description of an operation carried out by the pixel circuit in an operating state during a period t2 shown in the timing diagram of FIGS. 36A to 36E;

FIG. 39 is a circuit diagram to be referred to in description of an operation carried out by the pixel circuit in an operating state during a period t3 shown in the timing diagram of FIGS. 36A to 36E as a period allocated to a threshold-voltage compensation preparatory process;

FIG. 40 is a circuit diagram to be referred to in description of an operation carried out by the pixel circuit in an operating state during a period t4 shown in the timing diagram of FIGS. 36A to 36E as a period allocated to a threshold-voltage compensation process;

FIG. 41 is a circuit diagram to be referred to in description of an operation carried out by the pixel circuit in an operating state during the end part of the period t4 shown in the timing diagram of FIGS. 36A to 36E as a period allocated to a threshold-voltage compensation process;

FIG. 42 is a circuit diagram to be referred to in description of an operation carried out by the pixel circuit in an operating state of a mobility compensation process and a signal storing process during a period t5 shown in the timing diagram of FIGS. 36A to 36E and a period t6 immediately lagging behind the period t5;

FIG. 43 is a circuit diagram to be referred to in description of an operation carried out by the pixel circuit in a light emission state of the pixel circuit during a period t7 shown in the timing diagram of FIGS. 36A to 36E;

FIG. 44 is a conceptual block diagram showing an electronic instrument;

FIG. 45 is a diagram showing a squint view of the external appearance of a TV set serving as an electronic instrument employing an organic EL display panel to which the embodiments of the present invention are applied;

FIGS. 46A and 46B are diagrams each showing a squint view of the external appearance of a digital camera employing the organic EL display panel to which the embodiments of the present invention are applied;

FIG. 47 is a diagram showing a squint view of the external appearance of a video camera employing the organic EL display panel to which the embodiments of the present invention are applied;

FIGS. 48A and 48B are diagrams each showing the external appearance of a portable terminal such as a cellular phone employing the organic EL display panel to which the embodiments of the present invention are applied; and

FIG. 49 is a diagram showing a squint view of the external appearance of a notebook personal computer employing the organic EL display panel to which the embodiments of the present invention are applied.

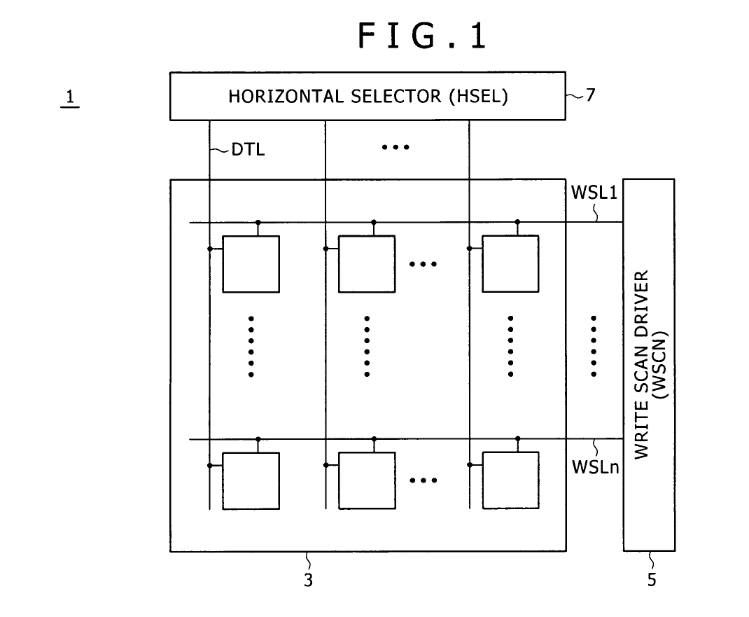

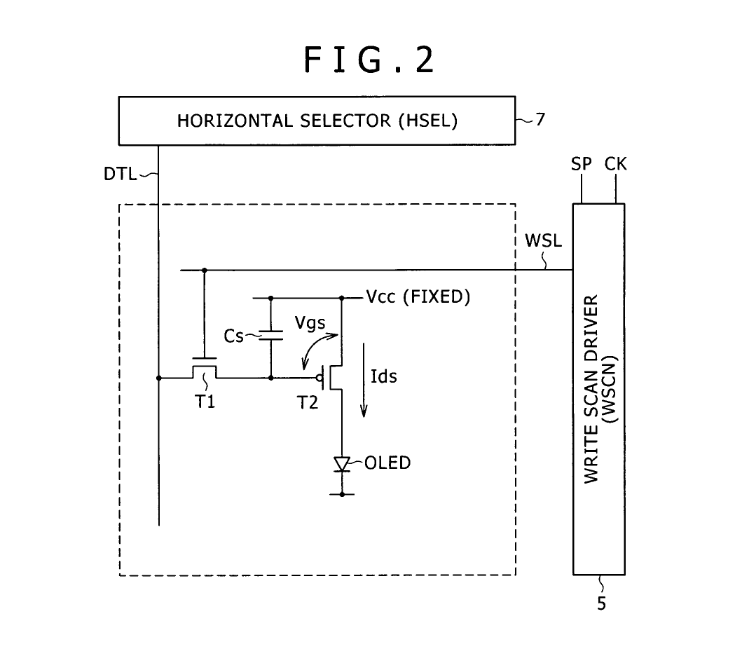

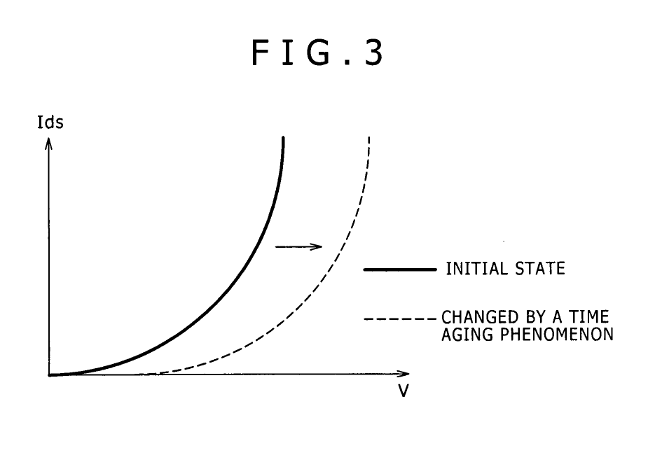

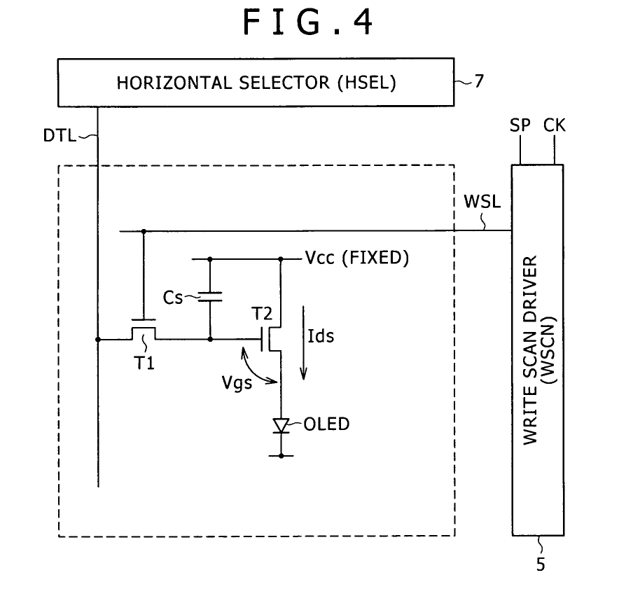

### DETAILED DESCRIPTION OF THE PREFERRED EMBODIMENTS

The following description explains an organic EL (Electro Luminescence) display panel provided by the embodiments of the present invention to serve as an organic EL display panel which adopts an active matrix driving method. It is to be noted that each of elements employed in the organic EL display panel but shown in none of diagrams can be assumed to be an element based on a commonly known technology pertaining to the same field as the present invention or a technology disclosed to the public as a technology pertaining to the same field. In addition, embodiments explained in the following description are no more than typical implementations of the present invention. That is to say, implementations of the present invention are by no means limited to the embodiments.

### (A): External Configuration

It is to be noted that the technical term ‘organic EL display panel’ used in this invention specification means not only a display panel employing a pixel array section and a driving circuit which are created on the same substrate by carrying out the same semiconductor process, but also an organic EL display panel manufactured by implementing the driving circuit typically as an application-specific IC on the substrate underlying the pixel array section.

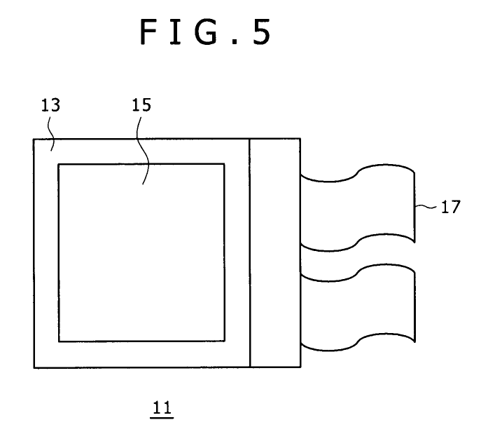

FIG. 5 is a diagram showing a typical external configuration of an organic EL display panel 11. The organic EL display panel 11 has a structure including a facing section 15 pasted on an area pertaining to a support substrate 13 to serve as an area in which a pixel array section is created.

The facing section 15 has a glass member or another transparent member to serve as the base and a protection film (or the like) laid on the surface. It is to be noted that the organic EL display panel 11 also includes an FPC (Flexible Print Circuit) 17 connected to the support substrate 13 to serve as a circuit for receiving a signal or the like from an external source and outputting a signal or the like to an external destination.

### (B): First Embodiment

### (B-1): System Configuration

The following description explains a typical system configuration of the organic EL display panel 11 which is capable of getting rid of effects of characteristic variations exhibited by the device driving transistor T2 employed in the pixel circuit and capable of operating by making use of only few components composing the pixel circuit.

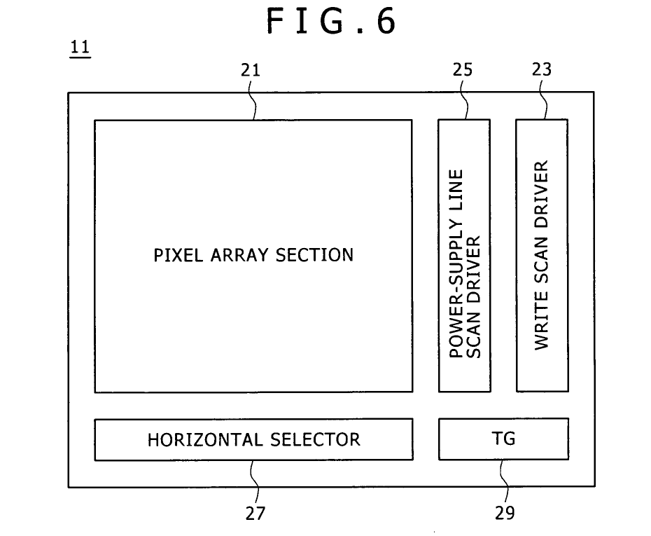

FIG. 6 is a block diagram showing a typical system configuration of the organic EL display panel 11 according to a first embodiment. The organic EL display panel 11 shown in the block diagram of FIG. 6 employs a pixel array section 21, a write scan driver 23, a power-supply line scan driver 25, a horizontal selector 27 and a time generator 29. Each of the write scan driver 23, the power-supply line scan driver 25 and the horizontal selector 27 serves as a driving circuit.

The pixel array section 21 has a matrix structure which is a matrix of sub-pixel circuits each located at the intersection of one of data signal lines DTL and one of write scan lines WSL. By the way, the sub-pixel circuit is the smallest unit of a pixel structure composing one pixel circuit. In general, one pixel circuit functioning as a white unit is configured to have three sub-pixel circuits, i.e., R (red), G (green) and B (blue) sub-pixel circuits which are made of organic EL materials different from each other.

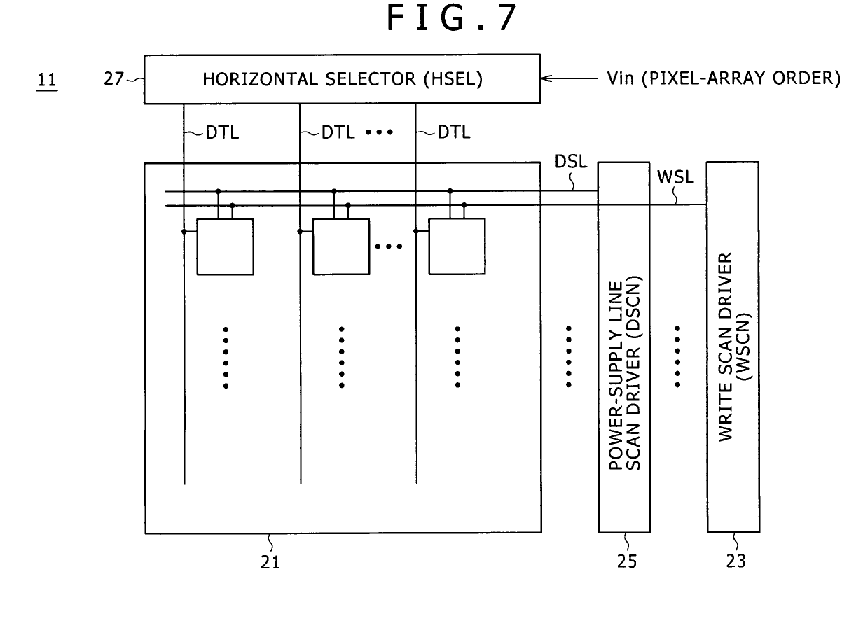

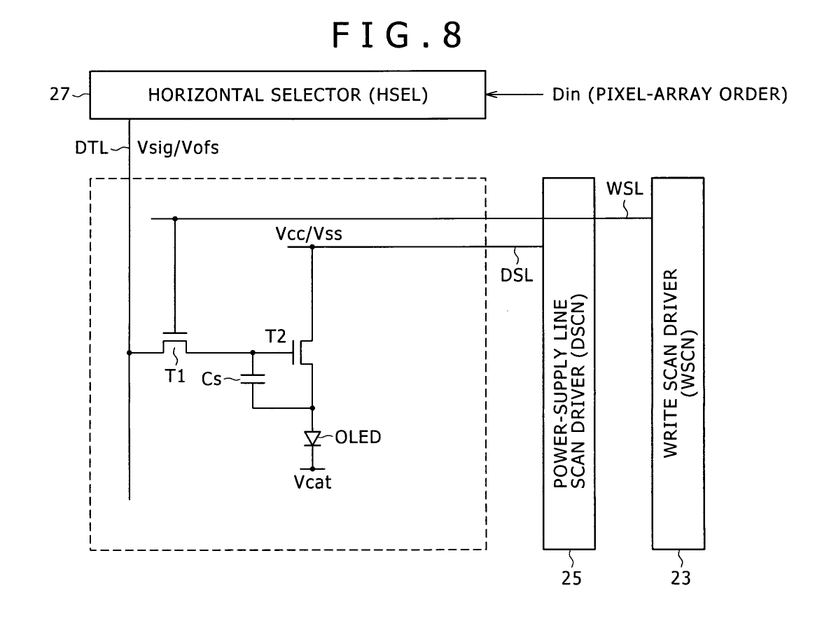

FIG. 7 is a block diagram showing connections between pixel circuits each serving as the circuit of a sub-pixel and the driving circuits. FIG. 8 is a diagram showing the internal configuration of a pixel circuit according to the proposed first embodiment. The pixel circuit shown in the diagram of FIG. 8 is configured to include two thin-film transistors T1 and T2 of the N-channel type and a signal holding capacitor Cs.

Also in the case of this pixel circuit, the write scan driver 23 controls operations to put the signal sampling transistor T1 in a turned-on state or a turned-off state by asserting a control signal on the write scan line WSL. By controlling the operations to put the signal sampling transistor T1 in a turned-on state or a turned-off state, it is possible to control an operation to store an electric potential asserted on the data signal line DTL into the signal holding capacitor Cs. By the way, the write scan driver 23 is configured to have a shift register which has as many output stages as desired to implement a vertical resolution of the displayed image.

The power-supply line scan driver 25 asserts a driving voltage having two different electric potentials on the power-supply line DSL connected to a specific one of two main electrodes of the device driving transistor T2 in order to control the operation of the pixel circuit in a manner of being interlocked with operations carried out by the other driving circuits. The operation of the pixel circuit includes not only a light emission process and no-light emission process of the organic EL light emitting device OLED, but also processes of compensating a drain-source current Ids generated by the device driving transistor T2 for variations of characteristics of the device driving transistor T2. To put it more concretely, the processes of compensating a drain-source current Ids generated by the device driving transistor T2 for variations of characteristics of the device driving transistor T2 are a process of compensating a drain-source current Ids generated by the device driving transistor T2 for variations of the threshold voltage of the device driving transistor T2 and a process of compensating a drain-source current Ids generated by the device driving transistor T2 for variations of the mobility of the device driving transistor T2. The processes of compensating a drain-source current Ids generated by the device driving transistor T2 for variations of characteristics of the device driving transistor T2 are carried out in order to avoid deteriorations of the uniformity of the displayed image.

The horizontal selector 27 asserts a video-signal electric potential Vsig representing pixel data Din or an offset electric potential Vofs for the process of compensating a drain-source current Ids generated by the device driving transistor T2 for variations of the threshold voltage of the device driving transistor T2 on the data signal line DTL. The horizontal selector 27 is configured to have a shift register having as many output stages as desired to implement a horizontal resolution of the displayed image. The horizontal selector 27 also employs a latch circuit provided for the output stages and a D/A converter provided for the latch circuit.

The time generator 29 is a circuit device for generating timing pulses desired for driving the write scan line WSL, the power-supply line DSL and the data signal line DTL.

### (B-2): Typical Driving Operations

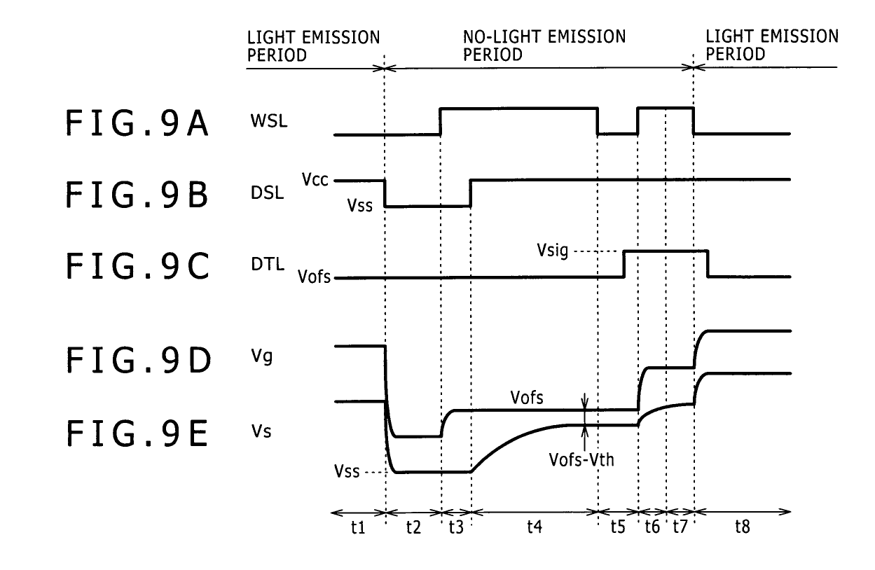

FIGS. 9A to 9E are a timing diagram showing a timing chart of every signal generated during a typical driving operation carried out by the pixel circuit shown in the diagram of FIG. 8. By the way, two different power-supply electric potentials are asserted on the DSL as shown in the timing diagram of FIGS. 9A to 9E. One of the two power-supply electric potentials is a high-level power-supply electric potential Vcc serving as a light emission electric potential whereas the other power-supply electric potential is a low-level power-supply electric potential Vss serving as a no-light emission electric potential.

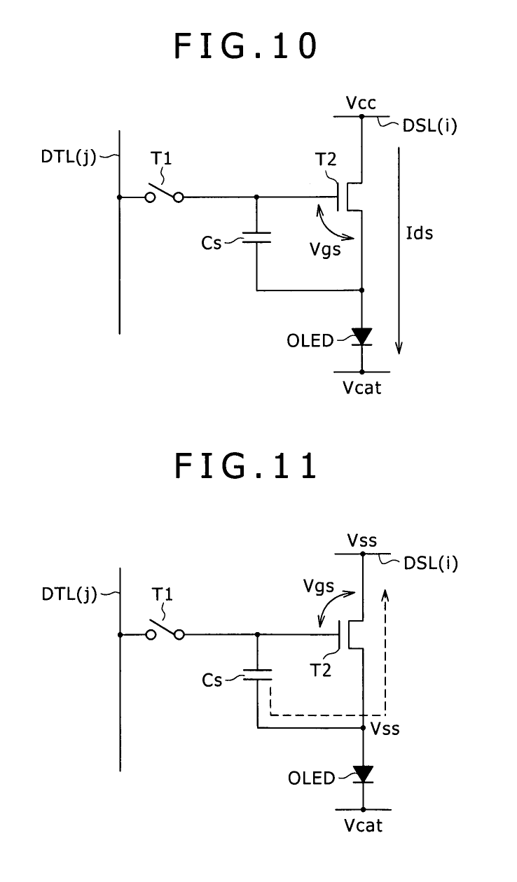

First of all, FIG. 10 is provided to serve as a circuit diagram referred to in description of an operation carried out by the pixel circuit in a light emission state of the pixel circuit. In this light emission state, the signal sampling transistor T1 is sustained in a turned-off state. On the other hand, the device driving transistor T2 is operating in a saturated region and generating a drain-source current Ids with a magnitude according to a gate-source voltage Vgs appearing between the gate and source electrodes of the device driving transistor T2 in a period t1 shown in the timing diagram of FIGS. 9A to 9E.

Next, an operation carried out by the pixel circuit in a no-light emission state of the pixel circuit is explained. This no-light emission state is started when the electric potential asserted on the power-supply line DSL is changed from the high-level power-supply electric potential Vcc to the low-level power-supply electric potential Vss at the beginning of a period t2 shown in the timing diagram of FIGS. 9A to 9E. If the low-level power-supply electric potential Vss is smaller than the sum of the threshold voltage Vthel of the organic EL light emitting device OLED and the cathode voltage Vcath supplied to the cathode electrode of the organic EL light emitting device OLED, that is, if the relation Vss<(Vthel+Vcath) is satisfied, the organic EL light emitting device OLED ceases to emit light.

It is to be noted that the source electric potential Vs appearing on the source electrode of the device driving transistor T2 is equal to the electric potential asserted on the power-supply line DSL. That is to say, the anode electrode of the organic EL light emitting device OLED is electrically charged to the low-level power-supply electric potential Vss. FIG. 11 is a circuit diagram showing the pixel circuit in an operating state during the period t2. As shown by a dashed line in the circuit diagram of FIG. 11, at that time, electric charge accumulated in the signal holding capacitor Cs is being withdrawn to the power-supply line DSL.

The data signal line DTL has been sustained at an offset electric potential Vofs used in execution of a threshold-voltage compensation process. Then, when the electric potential asserted on the write scan line WSL is changed to a high-level electric potential, the signal sampling transistor T1 is put in a turned-on state, allowing the electric potential appearing on the gate electrode of the device driving transistor T2 to change to the offset electric potential Vofs at the beginning of a period t3 shown in the timing diagram of FIGS. 9A to 9E.

FIG. 12 is a circuit diagram showing the pixel circuit in an operating state during the period t3 allocated to the so-called a threshold-voltage compensation preparatory process. In this operating state, the gate-source voltage Vgs appearing between the gate and source electrodes of the device driving transistor T2 is equal to a voltage difference (Vofs−Vss). The voltage difference (Vofs−Vss) is set at a magnitude greater than the threshold voltage Vth of the device driving transistor T2, that is, the voltage difference (Vofs−Vss) is set at such a magnitude that the relation (Vofs−Vss)>Vth is satisfied. This is because, if the magnitude of the voltage difference (Vofs−Vss) is not greater than the threshold voltage Vth of the device driving transistor T2, the threshold-voltage compensation process cited above may not be carried out.

Then, the electric potential asserted on the power-supply line DSL is changed from the low-level power-supply electric potential Vss to the high-level power-supply electric potential Vcc at the beginning of a period t4 shown in the timing diagram of FIGS. 9A to 9E. When the electric potential asserted on the power-supply line DSL is changed from the low-level power-supply electric potential Vss to the high-level power-supply electric potential Vcc, the electric potential Vs appearing on the source electrode of the device driving transistor T2 (that is, the electric potential appearing on the anode electrode of the organic EL light emitting device OLED) rises to the high-level power-supply electric potential Vcc.

FIG. 13 is a circuit diagram showing the pixel circuit in an operating state during the period t4 allocated to the so-called threshold-voltage compensation process. The circuit diagram of FIG. 13 also shows an equivalent circuit of the organic EL light emitting device OLED. The equivalent circuit of the organic EL light emitting device OLED has a diode representing the organic EL light emitting device OLED and a parasitic capacitor Cel of the organic EL light emitting device OLED. In this operating state, as long as the relation Vel≦(Vcat+Vthel) is satisfied, the drain-source current Ids generated by the device driving transistor T2 is used for electrically charging the signal holding capacitor Cs and the parasitic capacitor Cel provided that a leak current flowing through the organic EL light emitting device OLED can be considered to be much smaller than the drain-source current Ids generated by the device driving transistor T2. Reference notation Vel used in the relation denotes an electric potential appearing on the anode electrode of the organic EL light emitting device OLED.

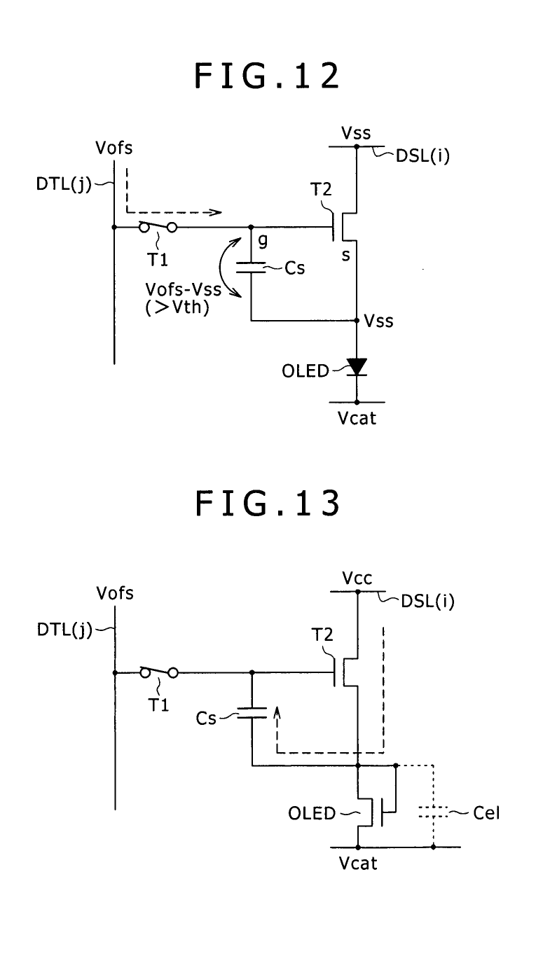

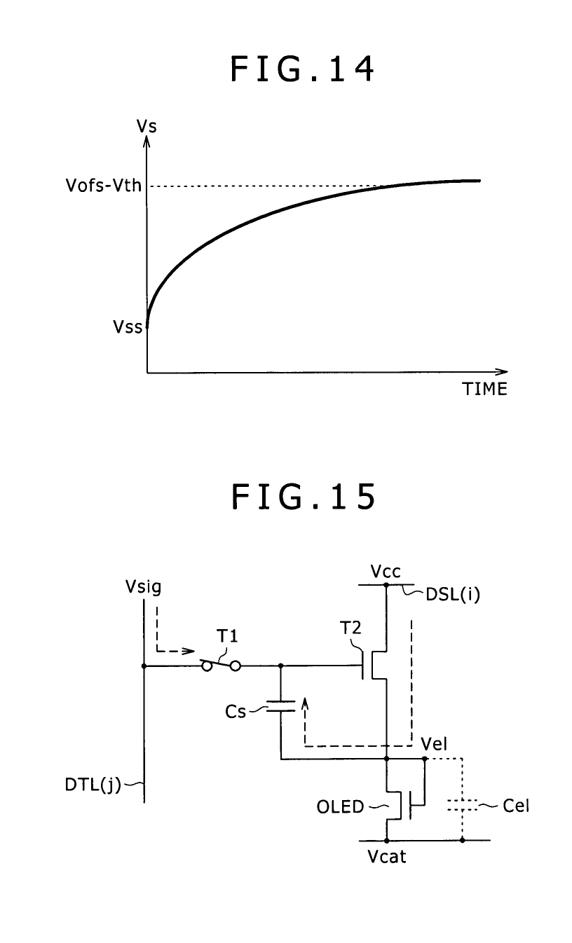

As a result, the anode electric potential Vel appearing on the anode electrode of the organic EL light emitting device OLED rises with the lapse of time as shown in a diagram of FIG. 14. That is to say, while the gate electric potential Vg appearing on the gate electrode of the device driving transistor T2 is being kept at the offset electric potential Vofs, the source electric potential Vs appearing on the source electrode of the device driving transistor T2 is rising. The operation to raise the source electric potential Vs appearing on the source electrode of the device driving transistor T2 during the period t4 is referred to as the threshold-voltage compensation process cited above.

In the course of time, the gate-source voltage Vgs appearing between the gate and source electrodes of the device driving transistor T2 is converged to the threshold voltage Vth of the device driving transistor T2. At that time, the source electric potential Vs appearing on the source electrode of the device driving transistor T2 is expressed by the following relations:

Vs=Vel=Vofs−Vth≦Vcat+Vthel

When the gate-source voltage Vgs appearing between the gate and source electrodes of the device driving transistor T2 attains the threshold voltage Vth of the device driving transistor T2, the threshold-voltage compensation process is ended and the signal sampling transistor T1 is again put in a turned-off state at the beginning of a period t5 shown in the timing diagram of FIGS. 9A to 9E.

During the period t5, the electric potential asserted on data signal line DTL is changed from the offset electric potential Vofs to the video-signal electric potential Vsig. Then, at the beginning of a period t6 shown in the timing diagram of FIGS. 9A to 9E, that is, after a sufficient setup time for the video-signal electric potential Vsig has been established, the signal sampling transistor T1 is again put in a turned-on state. FIG. 15 is a circuit diagram showing the pixel circuit in an operating state during the period t6 and a period t7 immediately lagging behind the period t6. The video-signal electric potential Vsig is an electric potential representing the gradation of the pixel circuit. During the periods t6 and t7, a signal storing process and a mobility compensation process are carried out.

Since the video-signal electric potential Vsig asserted on the data signal line DTL is supplied to the gate electrode of the device driving transistor T2, the gate electric potential Vg appearing on the gate electrode of the device driving transistor T2 is also rising from the offset electric potential Vofs to the video-signal electric potential Vsig during the period t6. Since a drain-source current Ids generated by the device driving transistor T2 is flowing from the power-supply line DSL to the signal holding capacitor Cs during the period t6, the source electric potential Vs appearing on the source electrode of the device driving transistor T2 is also rising with the lapse of time.

At this time, if the source electric potential Vs appearing on the source electrode of the device driving transistor T2 does not exceed the sum of the threshold voltage Vthel of the organic EL light emitting device OLED and the cathode voltage Vcat appearing on the cathode electrode of the organic EL light emitting device OLED, the drain-source current Ids generated by the device driving transistor T2 is used for electrically charging the signal holding capacitor Cs and the parasitic capacitor Cel provided that a leak current flowing through the organic EL light emitting device OLED can be considered to be much smaller than the drain-source current Ids generated by the device driving transistor T2.

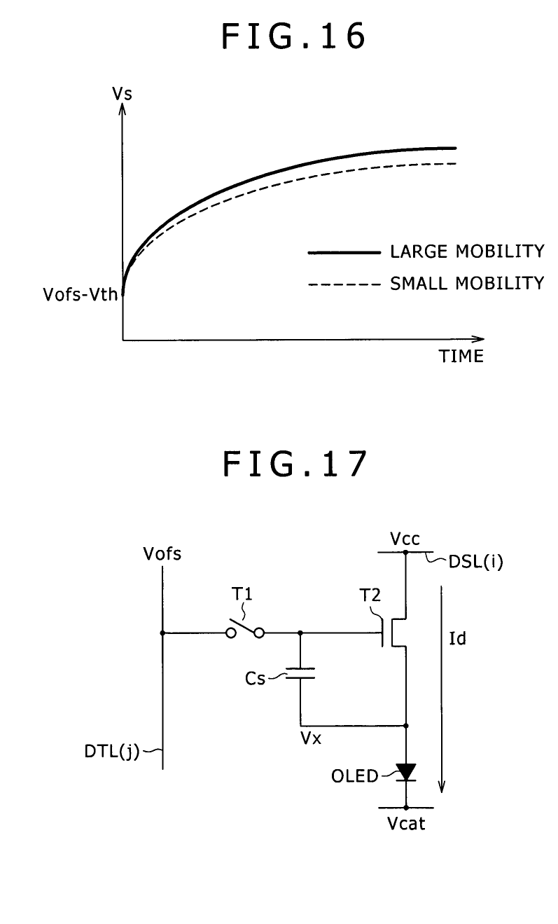

It is to be noted that, since the threshold-voltage compensation process of the device driving transistor T2 has already been completed, the magnitude of the drain-source current Ids generated by the device driving transistor T2 reflects the mobility μ of the device driving transistor T2. To put it more concretely, the larger the mobility μ of the device driving transistor T2, the larger the magnitude of the drain-source current Ids generated by the device driving transistor T2 and the higher the speed at which the source electric potential Vs appearing on the source electrode of the device driving transistor T2 is rising. Conversely, the smaller the mobility μ of the device driving transistor T2, the smaller the magnitude of the drain-source current Ids generated by the device driving transistor T2 flowing through the device driving transistor T2 and the lower the speed at which the source electric potential Vs appearing on the source electrode of the device driving transistor T2 is rising. A relation between the mobility of the device driving transistor T2 and the speed at which the source electric potential Vs appearing on the source electrode of the device driving transistor T2 is rising is indicated by curves shown in a diagram of FIG. 16.

As a result, the voltage stored in the signal holding capacitor Cs is compensated for variations in mobility μ. That is to say, the gate-source voltage Vgs appearing between the gate and source electrodes of the device driving transistor T2 is corrected to a value determined in accordance with the mobility μ. To put it more concretely, the gate-source voltage Vgs appearing between the gate and source electrodes of the device driving transistor T2 is corrected to a relatively large value for a device driving transistor T2 having a relatively small mobility μ or a relatively small value for a device driving transistor T2 having a relatively large mobility μ. The operation to correct the gate-source voltage Vgs appearing between the gate and source electrodes of the device driving transistor T2 to a value determined in accordance with the mobility μ is referred to as a mobility compensation process which is carried out during the periods t6 and t7 shown in the timing diagram of FIGS. 9A to 9E. It is to be noted that, during the periods t6 and t7, a signal writing process of storing the electric potential of a video signal Vsig into the signal holding capacitor Cs is also carried out as well.

Finally, the signal sampling transistor T1 is put in a turned-off state at the beginning of a period t8 shown in the timing diagram of FIGS. 9A to 9E in order to end the signal writing process of storing the electric potential of a video signal Vsig into the signal holding capacitor Cs and start the next light emission period of the organic EL light emitting device OLED. FIG. 17 is a circuit diagram showing the pixel circuit in an operating state during the period t8. It is to be noted that, in the light emission period, the gate-source voltage Vgs appearing between the gate and source electrodes of the device driving transistor T2 is held at a fixed magnitude by a coupling effect of the signal holding capacitor Cs. Thus, in this light emission period, the device driving transistor T2 is outputting a constant drain-source current Ids generated by the device driving transistor T2 to the organic EL light emitting device OLED.

In this light emission period, the source electric potential Vs appearing on the source electrode of the device driving transistor T2 and the anode electric potential Vel appearing on the anode electrode of the organic EL light emitting device OLED are rising to an electric potential Vx which allows the drain-source current Ids generated by the device driving transistor T2 to flow to the organic EL light emitting device OLED, starting the light emission state of the organic EL light emitting device OLED. In the light emission state, the organic EL light emitting device OLED is emitting light.

By the way, even in the case of the pixel circuit according to the first embodiment, the I-V characteristic of the organic EL light emitting device OLED also changes due to the so-called time aging phenomenon.

The source electric potential Vs appearing on the source electrode of the device driving transistor T2 also changes due to the variation of the I-V characteristic of the organic EL light emitting device OLED. Since the gate-source voltage Vgs appearing between the gate and source electrodes of the device driving transistor T2 is held at a fixed magnitude by a coupling effect of the signal holding capacitor Cs, however, the drain-source current Ids originating from the device driving transistor T2 as a current flowing to the organic EL light emitting device OLED does not change either. By making use of the pixel circuit according to the first embodiment and adopting a driving method provided for the pixel circuit as described above, the drain-source current Ids generated by the device driving transistor T2 as a current flowing to the organic EL light emitting device OLED can be sustained as at a constant magnitude determined by the gate-source voltage Vgs appearing between the gate and source electrodes of the device driving transistor T2 in spite of the fact that the I-V characteristic of the organic EL light emitting device OLED also changes due to the so-called time aging phenomenon. Thus, the luminance of light emitted by the organic EL light emitting device OLED can be sustained at a magnitude determined by the video-signal electric potential Vsig.

### (B-3): Conclusion

As described above, by making use of the pixel circuit according to the first embodiment and adopting a driving method provided for the pixel circuit, it is possible to implement an organic EL display panel without luminance variations from pixel to pixel even if a thin-film transistor of the N-channel type is employed to serve as the device driving transistor T2.

### (C): Second Embodiment

### (C-1): System Configuration

### (a): Wiring Structure

The following description explains a wiring structure of the organic EL display panel and a driving method provided for the pixel circuit employed in the organic EL display panel. The wiring structure and the driving method are provided by a second embodiment and allow the cost of manufacturing the organic EL display panel to be reduced.

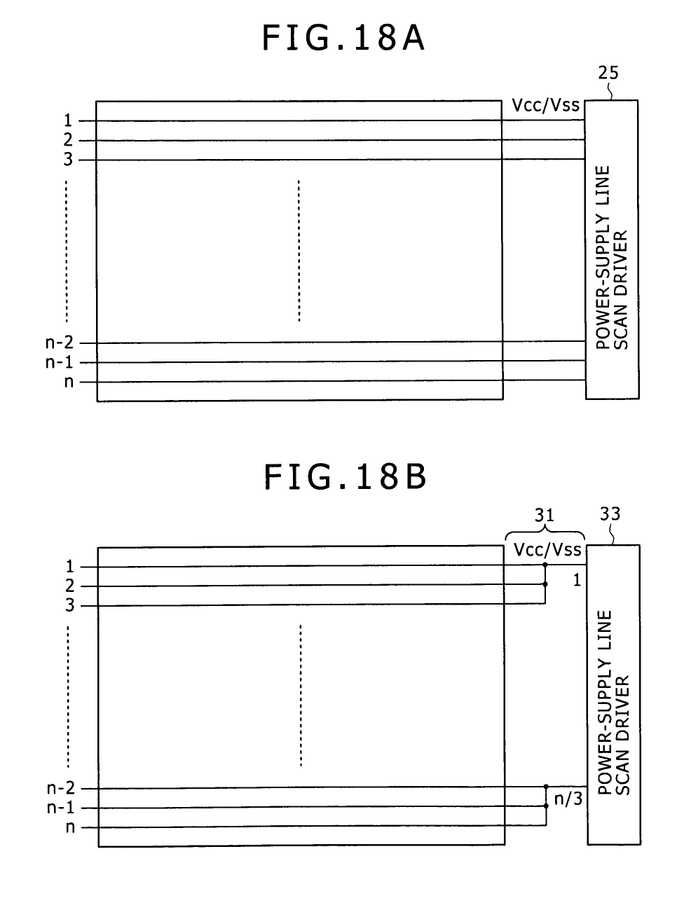

FIG. 18B is a diagram showing a wiring structure 31 of power-supply lines DSL employed in the pixel array section according to the second embodiment. By the way, for the purpose of comparison, FIG. 18A is given as a diagram showing a wiring structure of power-supply lines DSL employed in the pixel array section 21 according to the first embodiment.

In either of the wiring structures, a power-supply line DSL is stretched in the horizontal direction for every matrix row. In the case of the wiring structure shown in the diagram of FIG. 18A as the wiring structure of power-supply lines DSL employed in the pixel array section 21 according to the first embodiment, however, it is necessary to individually drive each of the power-supply lines DSL. That is to say, as the power-supply line scan driver 25, it is necessary to employ a shift register having as many output stages as desired to implement a vertical resolution of the displayed image.

In particular, in the case of a power-supply line scan driver, it is necessary to have a current flowing through a power-supply line DSL. It is thus necessary to increase the size of a buffer serving as a driver and a scanner (or a shift register) which form the power-supply line scan driver.

Therefore, in the case of the wiring structure shown in the diagram of FIG. 18A as the wiring structure of power-supply lines DSL employed in the pixel array section 21 according to the first embodiment in which it is necessary to individually drive each of the power-supply lines DSL, the area of the power-supply line scan driver has to be increased. That is to say, it is difficult to reduce the size of the pixel array section 21. In addition, the number of stages in the shift register serving as the power-supply line scan driver 25 is large and the operating clock frequency is high. It is thus hard to reduce the cost of manufacturing the power-supply line scan driver 25.

In the case of the wiring structure shown in the diagram of FIG. 18B as a wiring structure according to the second embodiment, on the other hand, three adjacent power-supply lines DSL share common operation timings. To put it more concretely, the terminals pertaining to the three adjacent power-supply lines DSL as terminals located on the same side of the pixel array section are electrically tied to each other in order to form a three-consecutive-row bundle which is driven by a power-supply line scan driver 33 in accordance with a driving method provided by the second embodiment. As a result, the number of output stages in the power-supply line scan driver 33 can be reduced to one-third of n where notation n denotes the number of power-supply lines in the pixel array section and, thus, also denotes the vertical resolution.

It is needless to say that, since the number of output stages in the shift register according to the second embodiment is one-third of the number of output stages in the first embodiment, the size of the power-supply line scan driver 33 can be reduced substantially. In addition, the operating clock frequency of the power-supply line scan driver 33 can be reduced to one-third of the operating clock frequency of the first embodiment. Thus, the manufacturing cost is very low in comparison with the power-supply line scan driver 25 for the wiring structure shown in the diagram of FIG. 18A.

### (b): System Configuration

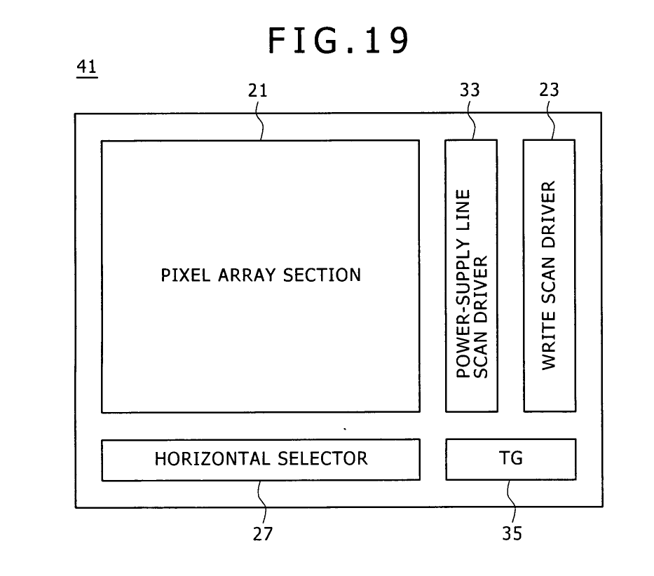

FIG. 19 is a block diagram showing a typical system configuration of an organic EL display panel 41 according to the second embodiment. In the block diagram of FIG. 19, configuration elements identical with their respective counterparts shown in the diagrams of FIGS. 6 and 18 are denoted by the same reference numerals as the counterparts.

The organic EL display panel 41 shown in the block diagram of FIG. 19 employs a pixel array section 21, a write scan driver 23, a power-supply line scan driver 33, a horizontal selector 27 and a timing generator 35. Each of the write scan driver 23, the power-supply line scan driver 33 and the horizontal selector 27 serves as a driving circuit.

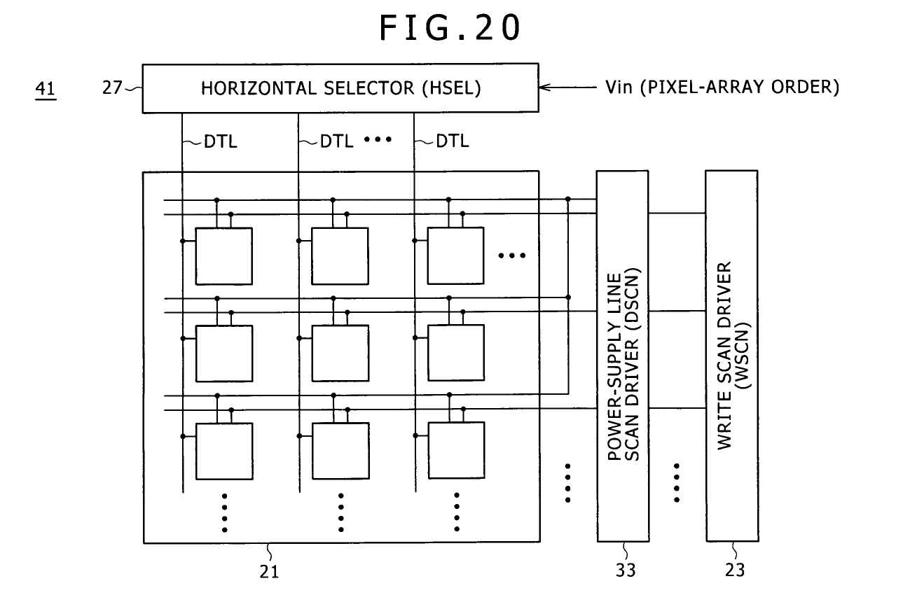

FIG. 20 is a block diagram showing connections between pixel circuits each serving as the circuit of a sub-pixel and the write scan driver 23, the power-supply line scan driver 33 as well as the horizontal selector 27 which are each used for driving the pixel circuits in the second embodiment. As shown in the block diagram of FIG. 20, in the case of the second embodiment, three adjacent power-supply lines DSL each stretched in the horizontal direction are tied to each other at a junction point on one side of the pixel array section 21 to form a three-consecutive-row bundle, and the junction point is connected to the power-supply line scan driver 33.

That is to say, the power-supply line scan driver 33 generates control signals with operation timings common to the three adjacent power-supply lines DSL which pertain to the three-consecutive-row bundle. Thus, the operating clock frequency at which the timing generator 35 supply an operating clock signal to the power-supply line scan driver 33 is one-third of the operating clock frequency of the time generator 29 employed in the first embodiment.

### (C-2): Driving Operations and Effects

### (a): Basic Driving Method

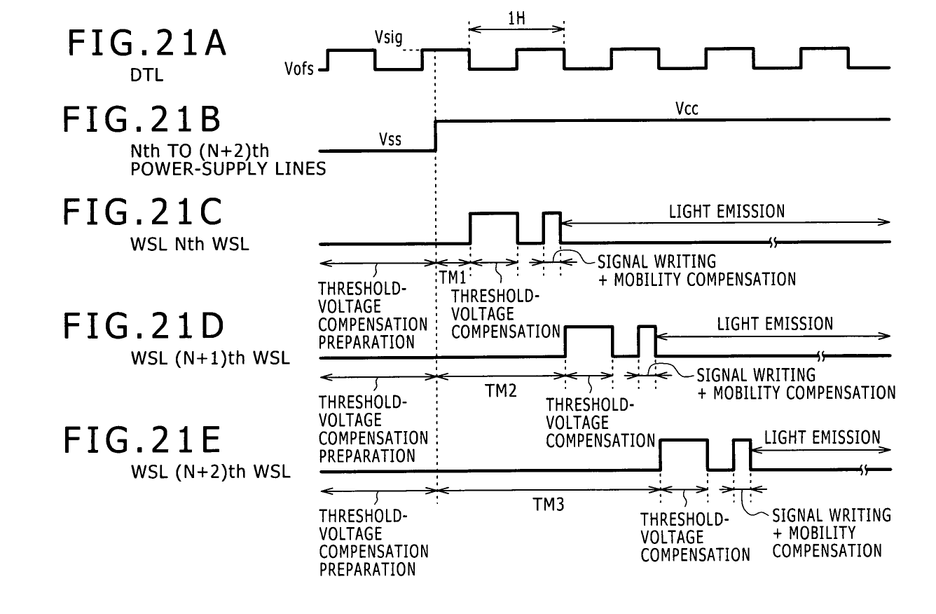

FIGS. 21A to 21E are a timing diagram showing a timing chart of each signal generated in basic driving operations according to the second embodiment. The waveforms of driving signals used in the first embodiment are used as they are in the timing diagram of FIG. 21. It is to be noted that the timing diagram of FIGS. 21A to 21E shows typical driving operations in which each of a threshold-voltage compensation preparatory process and a threshold-voltage compensation process, which are provided for the device driving transistors T2 connected to the three adjacent power-supply lines DSL, is carried out repeatedly in a plurality of horizontal scan periods each allocated to one of write scan lines WSL each associated with one of the three adjacent power-supply lines DSL.

By the way, FIG. 21A is a timing chart showing the waveform of a signal asserted on the data signal line DTL. As shown in the timing-chart/waveform diagram of FIG. 21A, the signal asserted on the data signal line DTL can be one of two signals, i.e., the video-signal electric potential Vsig or the offset electric Vofs. As described above, the offset electric potential Vofs is a reference electric potential used for carrying out the threshold-voltage compensation process of compensating the drain-source current Ids generated by the device driving transistor T2 for variations of the threshold voltage Vth of the device driving transistor T2.

FIG. 21B is a timing chart showing the waveform of a power-supply electric potential asserted on three adjacent power-supply lines DSL which are tied to each other to form a three-consecutive-row bundle. As shown in the timing-chart/waveform diagram of FIG. 21B, the low-level power-supply electric potential Vss is sustained till the end of the period of the threshold-voltage compensation preparatory process. At the end of the period of the threshold-voltage compensation preparatory process, the signal asserted on the three-consecutive-row bundle is changed from the low-level power-supply electric potential Vss to the high-level power-supply electric potential Vcc. It is to be noted that the assertion of the high-level power-supply electric potential Vcc on the three-consecutive-row bundle is sustained thereafter till the end of the light emission period of the last power-supply line DSL in the three-consecutive-row bundle consisting of the three adjacent power-supply lines DSL which are tied to each other.

FIG. 21C is a timing chart showing the waveform of a scan signal asserted on the write scan line WSL associated with the first power-supply line DSL in the three-consecutive-row bundle consisting of the three adjacent power-supply lines DSL which are tied to each other. FIG. 21D is a timing chart showing the waveform of a scan signal asserted on the write scan line WSL associated with the middle power-supply line DSL in the three-consecutive-row bundle. FIG. 21E is a timing chart showing the waveform of a scan signal asserted on the write scan line WSL associated with the last power-supply line DSL in the three-consecutive-row bundle.

However, a problem is expected to exist in the driving-signal waveforms shown in the timing diagram of FIG. 21. The problem is caused by an effect of a leak current attributed to time differences between the completion of the threshold-voltage compensation preparatory process and the starts of the threshold-voltage compensation processes. The time differences between the completion of the threshold-voltage compensation preparatory process and the starts of the threshold-voltage compensation processes are denoted by TM1 shown in the timing-chart/waveform diagram of FIG. 21C, TM2 (>TM1) shown in the timing-chart/waveform diagram of FIG. 21D and TM3 (>TM2) shown in the timing-chart/waveform diagram of FIG. 21E.

As also explained in the description of the first embodiment, at the end of the threshold-voltage compensation preparatory process, the gate-source voltage Vgs appearing between the gate and source electrodes of the device driving transistor T2 has been set at a magnitude greater than the threshold voltage Vth of the device driving transistor T2.

Thus, when the high-level power-supply electric potential Vcc is asserted on the power-supply line DSL, a leak current starts to flow from the power-supply line DSL to the device driving transistor T2, causing the source electric potential Vs appearing on the source electrode of the device driving transistor T2 to undesirably rise even if the threshold-voltage compensation process is not started as is the case with the second embodiment.

To put it more concretely, the source electric potential Vs appearing on the source electrode of the device driving transistor T2 undesirably rises. In addition, the larger the time difference between the completion of the threshold-voltage compensation preparatory process and the start of the threshold-voltage compensation process, the larger the electric-potential increase by which the source electric potential Vs appearing on the source electrode of the device driving transistor T2 rises. Since the gate electric potential Vg is sustained at the offset electric potential Vofs, the larger the electric-potential increase by which the source electric potential Vs appearing on the source electrode of the device driving transistor T2 rises, the smaller the gate-source voltage Vgs appearing between the gate and source electrodes of the device driving transistor T2. As a result, if the gate-source voltage Vgs appearing between the gate and source electrodes of the device driving transistor T2 becomes smaller than the threshold voltage Vth of the device driving transistor T2 at the start of the threshold-voltage compensation process, the threshold-voltage compensation process may not be carried out normally.

In particular, it is most quite within the bounds of possibility that the threshold-voltage compensation process for the device driving transistor T2 connected to the last power-supply line DSL in the three-consecutive-row bundle does not function normally since the time difference TM3 between the completion of the threshold-voltage compensation preparatory process and the start of the threshold-voltage compensation process is longest. It is also needless to say that, the larger the number of adjacent horizontal power-supply lines DSL pertaining to a multi-consecutive-row bundle, the higher the probability that the threshold-voltage compensation process for the device driving transistor T2 connected to the last power-supply line DSL in the multi-consecutive-row bundle does not function normally. If the threshold-voltage compensation process does not function normally, it is more quite within the bounds of possibility that the display screen shows visual abnormalities such as luminance unevenness and image cords.

### (b): Typical Improvement of the Driving Method

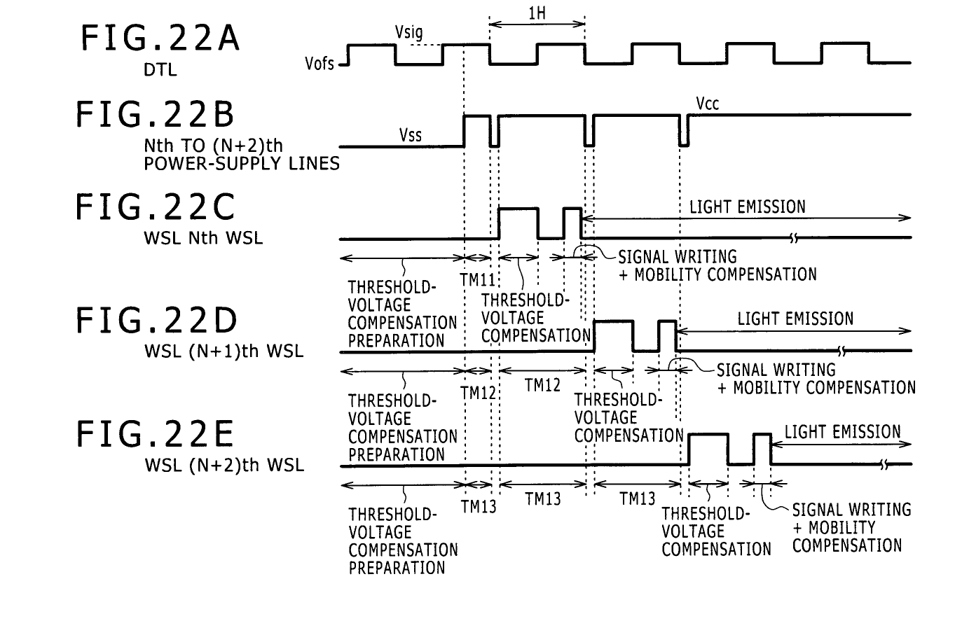

In order to solve the problem described above, a driving method according to timing diagram of FIGS. 22A to 22E has been proposed. The driving method to be explained below by referring to timing diagram of FIGS. 22A to 22E is different from the driving method shown in a timing diagram of FIGS. 21A to 21E in that, in the case of the driving method to be explained below by referring to the timing diagram of FIGS. 22A to 22E, while the data signal line DTL is being sustained at the offset electric potential Vofs during each of time periods between the completion of the threshold-voltage compensation preparatory process and the starts of the threshold-voltage compensation processes for the device driving transistors T2 connected to the adjacent power-supply lines DSL pertaining to the three-consecutive-row bundle, the power-supply electric potential asserted on the DSL is changed instantaneously from the high-level power-supply electric potential Vcc to the low-level power-supply electric potential Vss. That is to say, each of the time periods between the completion of the threshold-voltage compensation preparatory process and the starts of the threshold-voltage compensation processes for the device driving transistors T2 connected to the adjacent power-supply lines DSL pertaining to the three-consecutive-row bundle is provided with an instantaneous period during which the power-supply electric potential asserted on the DSL is sustained at the low-level power-supply electric potential Vss.

In the following description, a time period including the instantaneous periods, during each of which the power-supply electric potential asserted on the DSL is sustained at the low-level power-supply electric potential Vss is referred to as a power-supply electric-potential on/off driving period. It is to be noted that a timing to start the power-supply electric-potential on/off driving period can be prescribed as a timing coincident with the first transition of the electric potential asserted on the DSL from the low-level power-supply electric potential Vss to the high-level power-supply electric potential Vcc.

On the other hand, a timing to end the power-supply electric-potential on/off driving period can be prescribed as a timing to start the light emission period for a pixel circuit connected to the last one of the adjacent horizontal power-supply lines DSL pertaining to the three-consecutive-row bundle.

In the case of the driving method including the power-supply electric-potential on/off driving period as described above, while the power-supply electric potential asserted on the power-supply line DSL is being sustained at the low-level power-supply electric potential Vss, that is, while the power-supply electric potential asserted on the power-supply line DSL is controlled to remain in a turned-off state, the anode electric potential Vel becomes equal to the low-level power-supply electric potential Vss which is the electric potential appearing on the power-supply line DSL. Thus, a leak current does not flow from the power-supply line DSL to the device driving transistor T2.

Accordingly, the length of the time period between the completion of the threshold-voltage compensation preparatory process and the start of the threshold-voltage compensation process for the device driving transistor T2 connected to the power-supply line DSL pertaining to the three-consecutive-row bundle is reduced by the length of the power-supply electric-potential off driving period during which the power-supply electric potential asserted on the power-supply line DSL is sustained at the low-level power-supply electric potential Vss. In the following description, the power-supply electric potential asserted on the power-supply line DSL is also referred to as a driving voltage.

To put it more concretely, the time period TM11 shown in the timing diagram of FIGS. 22A to 22E as a period between the completion of the threshold-voltage compensation preparatory process and the start of the threshold-voltage compensation processes for the device driving transistor T2 connected to the first one of the three power-supply lines DSL pertaining to the three-consecutive-row bundle is shorter than the time period TM1 shown in the timing diagram of FIGS. 21A to 21E as a period between the completion of the threshold-voltage compensation preparatory process and the start of the threshold-voltage compensation process for the device driving transistor T2 connected to the first one of the three power-supply lines DSL pertaining to the three-consecutive-row bundle.

By the same token, the time period TM12 shown in the timing diagram of FIGS. 22A to 22E as a period between the completion of the threshold-voltage compensation preparatory process and the start of the threshold-voltage compensation processes for the device driving transistor T2 connected to the second one of the three power-supply lines DSL pertaining to the three-consecutive-row bundle is shorter than the time period TM2 shown in the timing diagram of FIGS. 21A to 21E as a period between the completion of the threshold-voltage compensation preparatory process and the start of the threshold-voltage compensation process for the device driving transistor T2 connected to the second one of the three power-supply lines DSL pertaining to the three-consecutive-row bundle.

In the same way, the time period TM13 shown in the timing diagram of FIGS. 22A to 22E as a period between the completion of the threshold-voltage compensation preparatory process and the start of the threshold-voltage compensation process for the device driving transistor T2 connected to the third one of the three power-supply lines DSL pertaining to the three-consecutive-row bundle is shorter than the time period TM3 shown in the timing diagram of FIGS. 21A to 21E as a period between the completion of the threshold-voltage compensation preparatory process and the start of the threshold-voltage compensation process for the device driving transistor T2 connected to the third one of the three power-supply lines DSL pertaining to the three-consecutive-row bundle.

In general, when a leak current is flowing to a capacitor, resulting in a change of an electric potential appearing on the capacitor, the electric-potential change caused by the leak current is proportional to 1/capacitance (that is, the reciprocal of the capacitance of the capacitor), the magnitude of the leak current and a period during which the leak current is flowing to the capacitor. Thus, if the time period between the completion of the threshold-voltage compensation preparatory process and the start of the threshold-voltage compensation process for the device driving transistor T2 connected to a power-supply line DSL pertaining to the three-consecutive-row bundle can be made short, the change of the source electric potential Vs appearing on the source electrode of the device driving transistor T2 can be reduced by a quantity corresponding to a difference by which the time period is made shorter.

In addition, even if a leak current flows from the power-supply line DSL to the device driving transistor T2 during a period in which the driving voltage asserted on the power-supply line DSL is sustained at the high-level power-supply electric potential Vcc, causing the source electric potential Vs appearing on the source electrode of the device driving transistor T2 to rise, a leak current flows from the device driving transistor T2 to the power-supply line DSL in the opposite direction during a period in which the driving voltage asserted on the power-supply line DSL is sustained at the low-level power-supply electric potential Vss.

Thus, the effect of the leak current flowing to the device driving transistor T2 can be reduced. As a result, the threshold-voltage compensation process for the device driving transistor T2 can be carried out normally. That is to say, by adopting the driving method explained above by referring to the timing diagram of FIGS. 22A to 22E, it is possible to prevent the display screen from showing visual abnormalities such as luminance unevenness and image cords.

In addition, by setting the driving voltage asserted on the adjacent horizontal power-supply lines DSL pertaining to the three-consecutive-row bundle at the high-level power-supply electric potential Vcc and the low-level power-supply electric potential Vss alternately and repeatedly till the completion of the threshold-voltage compensation process carried out for the last stage as shown in the timing chart of FIG. 22B, a threshold-voltage compensation process can be carried out during a threshold-voltage compensation period at a current stage under the same condition as the preceding stage. Thus, even if adjacent horizontal power-supply lines DSL are tied to each other to form a three-consecutive-row bundle and driving timings are used as timings common to the 3 adjacent horizontal power-supply lines DSL, it is possible to prevent the display screen from showing visual abnormalities such as luminance unevenness and shadings.

It is needless to say that, by tying adjacent horizontal power-supply lines DSL to each other to form a three-consecutive-row bundle, the number of driving stages of the power-supply line scan driver 33 can be reduced to one-third (⅓) of that of the first embodiment. That is to say, the frequency of the operating clock signal of the power-supply line scan driver 33 can be reduced to one-third (⅓) of that of the first embodiment. Thus, it is possible to implement an organic EL display panel having a manufacturing cost lower than that of the first embodiment. In particular, the second embodiment is effective for reduction of the manufacturing costs of an organic EL display panel having a large size and/or a high resolution.

### (D): Third Embodiment

### (D-1): System Configuration

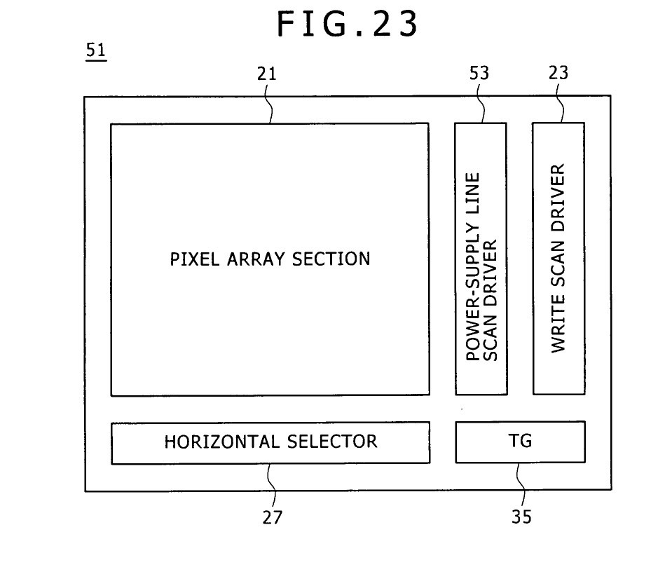

FIG. 23 is a block diagram showing a typical system configuration of an organic EL display panel 51 according to a third embodiment. In the block diagram of FIG. 23, configuration elements identical with their respective counterparts shown in the diagram of FIG. 19 are denoted by the same reference numerals as the counterparts.

The organic EL display panel 51 shown in the block diagram of FIG. 23 employs a pixel array section 21, a write scan driver 23, a power-supply line scan driver 53, a horizontal selector 27 and a timing generator 35. Each of the write scan driver 23, the power-supply line scan driver 53 and the horizontal selector 27 serves as a driving circuit.

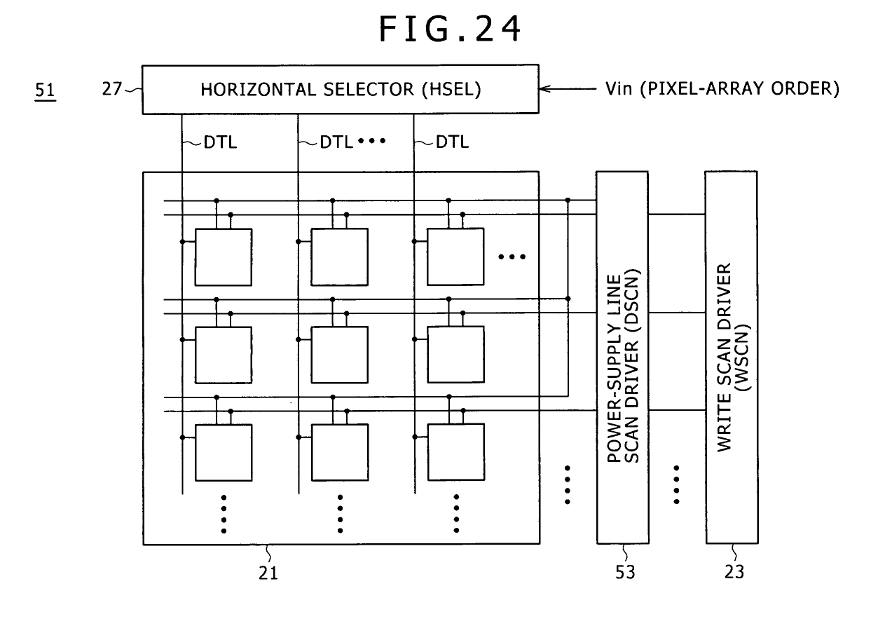

FIG. 24 is a block diagram showing connections between pixel circuits each serving as the circuit of a sub-pixel and the write scan driver 23, the power-supply line scan driver 53 as well as the horizontal selector 27 which are each used for driving the pixel circuits. As shown in the block diagram of FIG. 24, also in the case of the third embodiment, it is assumed that three adjacent power-supply lines DSL each stretched in the horizontal direction are tied to each other at a junction point on one side of the pixel array section 21 to form a three-consecutive-row bundle, and the junction point is connected to the power-supply line scan driver 53.

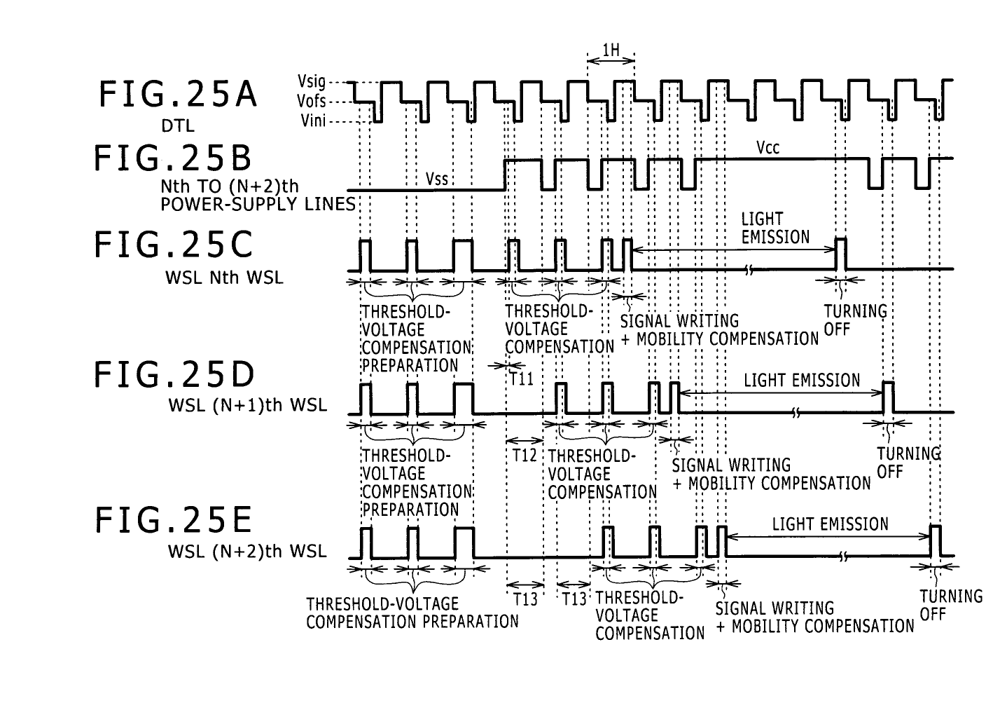

In addition, in the case of the third embodiment, each of a threshold-voltage compensation preparatory process and a threshold-voltage compensation process, which are provided for a device driving transistor T2 connected to one of the three adjacent power-supply lines DSL, is carried out repeatedly in a plurality of horizontal scan periods each allocated to one of the three adjacent power-supply lines DSL. In a timing diagram of FIGS. 25A to 25E, a horizontal scan period is indicated by notation 1 H shown in a timing chart of FIG. 25A. To put it more concretely, each of timing charts of FIGS. 25C, 25D and 25E shows a plurality of threshold-voltage compensation preparatory processes and a plurality of threshold-voltage compensation processes.

In the case of display panels developed so far, the resolution becomes higher as the display area of the screen is increased. Thus, time allocated to one horizontal scan period is shorter. In consequence, there is rising necessity to assume a case in which a threshold-voltage compensation preparatory process and/or a threshold-voltage compensation process may not be completed in 1 horizontal period. In order to solve this problem, in accordance with the third embodiment, execution of each of the threshold-voltage compensation preparatory process and the threshold-voltage compensation process is divided into in a plurality of horizontal scan periods.

### (D-2): Driving Operations and Effects

By the way, if the execution of each of the threshold-voltage compensation preparatory process and the threshold-voltage compensation process is divided into in a plurality of horizontal scan periods, each of the threshold-voltage compensation preparatory process and the threshold-voltage compensation process is executed and stopped at least once. It is thus necessary to take a countermeasure against a leak current flowing to the device driving transistor T2 in a stopped-execution period.

The timing diagram of FIGS. 25A to 25E includes a timing chart shown in FIG. 25B as a timing chart showing the waveform of the power-supply electric potential asserted on the power-supply line DSL to serve as a driving voltage in the third embodiment. It is to be noted that the timing diagram of FIGS. 25A to 25E also shows a driving method in accordance with which each of the threshold-voltage compensation preparatory process and the threshold-voltage compensation process is carried out three times as shown in the each of the timing charts of FIGS. 25C, 25D and 25E.

A timing chart shown in FIG. 25A shows the waveform of a signal asserted on the data signal line DTL. In the case of the third embodiment, the signal asserted on the data signal line DTL can be one of three signals, i.e., a video-signal electric potential Vsig, an offset electric potential Vofs and a reset electric potential Vini.

The reset electric potential Vini corresponds to an initially stored electric potential described in claims and the section having the title of Means for Solving the Problems. The reset electric potential Vini is an electric potential added to serve as a countermeasure against a leak current flowing to the device driving transistor T2 in a stopped-execution period. The reset electric potential Vini is an electric potential lower than the offset electric potential Vofs.

The reader is suggested to keep in mind that it is desirable to have a reset electric potential Vini matching an electric potential supplied to the gate electrode of the device driving transistor T2 at a point of time the execution of the threshold-voltage compensation preparatory process is ended. In addition, in order to sustain the source electric potential Vs appearing on the source electrode of the device driving transistor T2 at the low-level power-supply electric potential Vss to a certain degree during the periods of the threshold-voltage compensation preparatory process and the threshold-voltage compensation process, it is necessary to set the reset electric potential Vini at such a level that the difference (Vini−Vss) is smaller than the threshold voltage Vth of the device driving transistor T2.

In the case of the third embodiment, the reset electric potential Vini satisfying the conditions described above is asserted on the data signal line DTL with a timing to suspend the threshold-voltage compensation preparatory process and a timing to terminate the threshold-voltage compensation process as shown on the left-hand sides of the timing charts of FIGS. 25C, 25D and 25E. It is needless to say that the reset electric potential Vini is supplied to the gate electrode of the device driving transistor T2 during the no-light emission period by raising a scan signal asserted on the write scan line WSL associated with the power-supply line DSL connected to the device driving transistor T2 as shown on the right-hand sides of the timing charts of FIGS. 25C, 25D and 25E.

In the case of the driving method according to the timing diagram of FIGS. 25A to 25E, the reset electric potential Vini is supplied to the gate electrode of the device driving transistor T2 immediately before the start of a threshold-voltage compensation process in order to control the gate-source voltage Vgs appearing between the gate and source electrodes of the device driving transistor T2 to a level not exceeding the threshold voltage Vth of the device driving transistor T2. Thus, while the threshold-voltage compensation process is being suspended, the leak current no longer flows to the device driving transistor T2 even after the driving voltage asserted on the power-supply line DSL is changed from the high-level power-supply electric potential Vcc to the low-level power-supply electric potential Vss so that it is possible to prevent the source electric potential Vs appearing on the source electrode of the device driving transistor T2 from rising. As a result, a normal threshold-voltage compensation process can be carried out interruptedly.

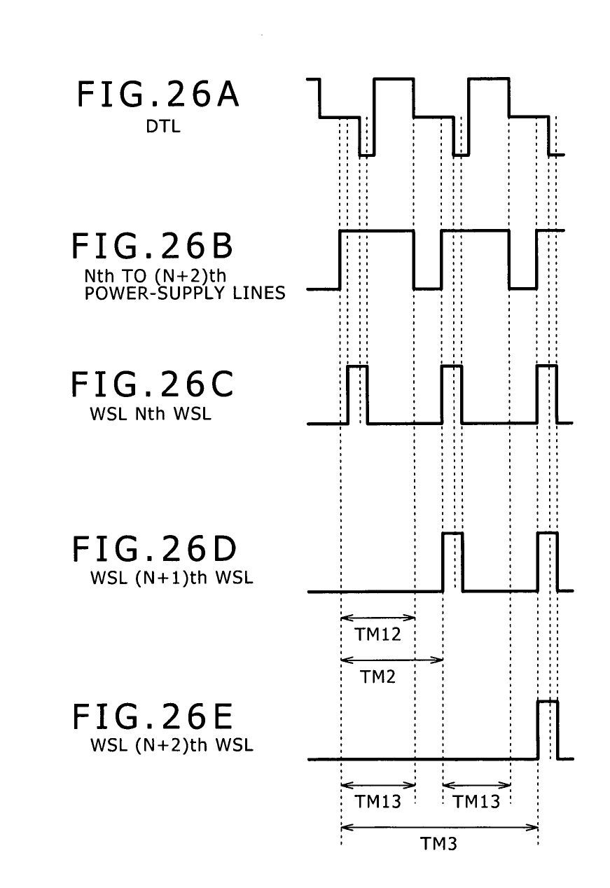

FIGS. 26A to 26E are a timing diagram showing time differences each measured as a difference in time between the end of a threshold-voltage compensation preparatory process and the start of a threshold-voltage compensation process as well as a relation between a timing to assert a high-level scan signal on the write scan line WSL for the threshold-voltage compensation process and a timing to assert a video signal Vsig on the data signal line DTL after the threshold-voltage compensation process. Timing charts of FIGS. 26A to 26E correspond to the timing charts of FIGS. 25A to 25E respectively. As shown in the timing diagram of FIGS. 26A to 26E, also in the case of the third embodiment, the difference of time between the end of a threshold-voltage compensation preparatory process and the start of a threshold-voltage compensation process for the device driving transistor T2 for the write scan line WSL associated with a write scan line WSL pertaining to the three-consecutive-row bundle is essentially small in comparison with a case in which the driving voltage asserted on the power-supply line DSL is sustained at the high-level power-supply electric potential Vcc. For example, it is obvious from the timing diagram of FIGS. 26A to 26E that the time difference TM12 relative to a reference time for the third embodiment is essentially smaller than the time difference TM2 relative to the same reference time for the second embodiment without changing the driving voltage asserted on the power-supply line DSL from the high-level power-supply electric potential Vcc to the low-level power-supply electric potential Vss as shown in the timing diagram of FIG. 21.

In addition, it is obvious from the timing diagram of FIGS. 26A to 26E that the period to store a reference signal in the signal holding capacitor Cs for the threshold-voltage compensation process by setting the scan signal asserted on the write scan line WSL at a high level crosses the boundary between the period to assert the offset electric potential Vofs on the data signal line DTL and the period to assert the reset electric potential Vini on the data signal line DTL.

As mentioned above, after the threshold-voltage compensation process has been started, the gate-source voltage Vgs appearing between the gate and source electrodes of the device driving transistor T2 rises to approach the threshold voltage Vth of the device driving transistor T2 during a period to assert the offset electric potential Vofs on the data signal line DTL and the gate electric potential Vg appearing on the gate electrode of the device driving transistor T2 is reset to the reset electric potential Vini during a period to assert the reset electric potential Vini on the data signal line DTL.

The timing chart of FIG. 25B shows the waveform of the power-supply electric potential asserted on each of the one of the three power-supply lines DSL pertaining to the three-consecutive-row bundle. In this case, the power-supply electric potential serving as the driving voltage is sustained at the low-level power-supply electric potential Vss till the threshold-voltage compensation preparatory processes are ended. Then, between the end of the execution of the threshold-voltage compensation preparatory processes and the end of the execution of the threshold-voltage compensation process for the third one of the three power-supply lines DSL pertaining to the three-consecutive-row bundle, the power-supply electric potential serving as the driving voltage is alternately changed from the low-level power-supply electric potential Vss to the high-level power-supply electric potential Vcc and vice versa. It is to be noted that the end of the execution of the threshold-voltage compensation process for the third one of the three power-supply lines DSL pertaining to the three-consecutive-row bundle is the start of the light emission process for the third one of the three power-supply lines DSL pertaining to the three-consecutive-row bundle.

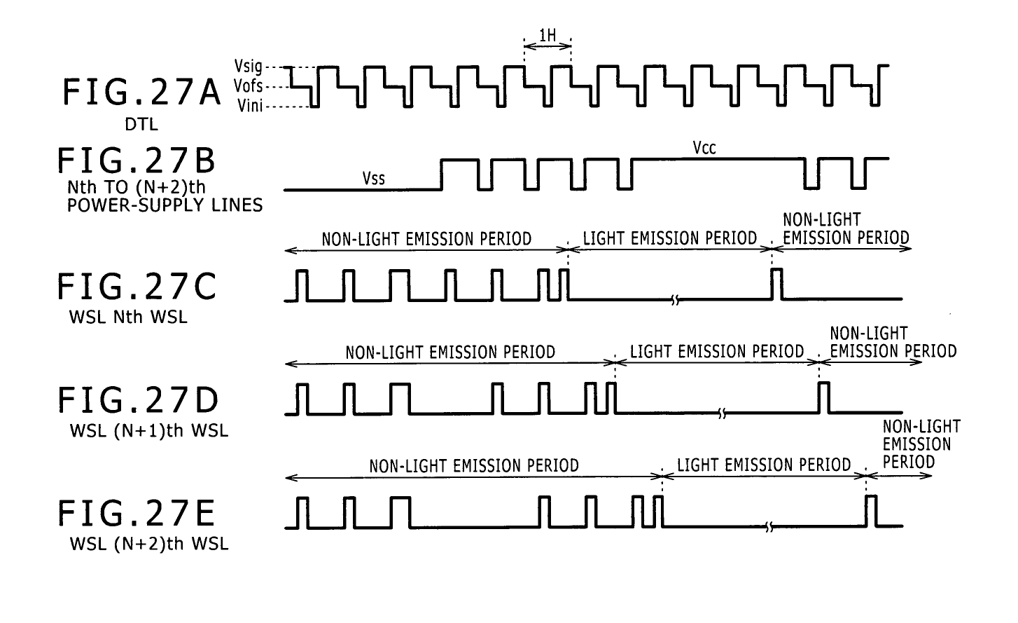

It is also worth noting that, it is not till the execution of the threshold-voltage compensation process for the third one of the three power-supply lines DSL pertaining to the three-consecutive-row bundle has been ended that the power-supply electric potential asserted on each of the power-supply line DSL pertaining to the three-consecutive-row bundle to serve as the driving voltage is sustained at the high-level power-supply electric potential Vcc as shown in a timing diagram of FIGS. 27A to 27E. In each of two consecutive horizontal scan periods immediately leading ahead of the end of the execution of the light emission process for the third one of the three power-supply lines DSL pertaining to the three-consecutive-row bundle, the power-supply electric potential asserted on each of the power-supply line DSL pertaining to the three-consecutive-row bundle to serve as the driving voltage is controlled to change to the low-level power-supply electric potential Vss as shown in the right end of a timing chart of FIG. 27B.

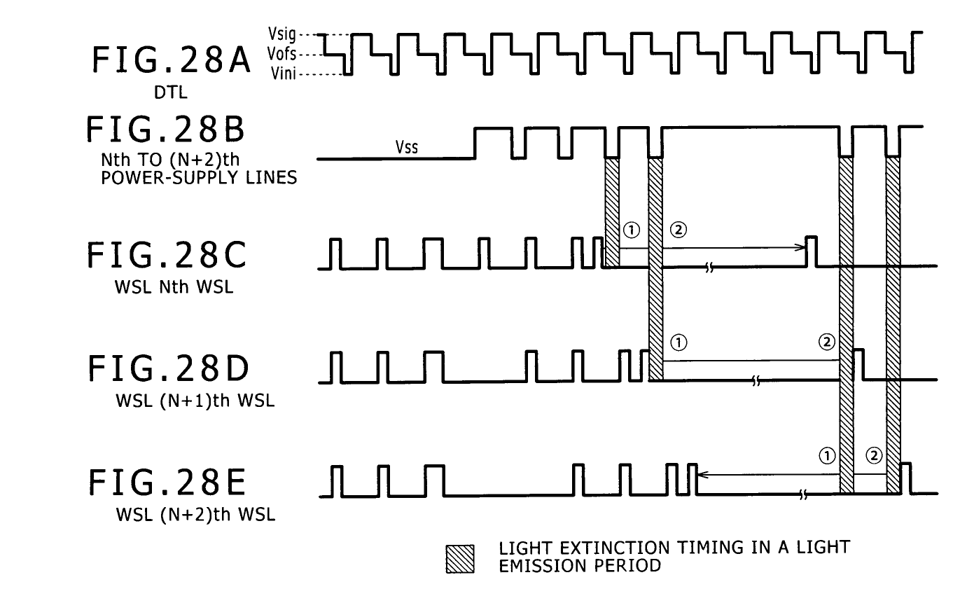

This operation is carried out in order to make the number of no-light emission periods within a light emission period uniform for write scan lines WSL associated with all the power-supply lines DSL pertaining to the three-consecutive-row bundle. In the timing diagram of FIGS. 28A to 28E, a no-light emission period within a light emission period is shown as a dark period. In the timing diagram of FIGS. 28A to 28E, a no-light emission period for a write scan line WSL is indicated by a number enclosed in a circle.

As shown in the timing diagram of FIGS. 28A to 28E, in each of two consecutive horizontal scan periods immediately leading ahead of the end of the execution of the light emission process for the third one of the three power-supply lines DSL pertaining to the three-consecutive-row bundle, the power-supply electric potential asserted on each of the power-supply lines DSL pertaining to the three-consecutive-row bundle to serve as the driving voltage is controlled to change to the low-level power-supply electric potential Vss in order to set the number of no-light emission periods within a light emission period at 2 which is a number uniform for write scan lines WSL associated with all the power-supply lines DSL pertaining to the three-consecutive-row bundle.

Since the no-light emission periods have the same length, the light emission period can be made uniform for all write scan lines WSL associated with the three power-supply lines DSL pertaining to the three-consecutive-row bundle.

In addition, it is desirable to set a no-light emission period with a timing to assert the reset electric potential Vini on the data signal line DTL. As shown in the timing diagram of FIGS. 28A to 28E, however, a no-light emission period does not have to be set with a timing to assert the reset electric potential Vini on the data signal line DTL.

It is to be noted that the timing chart of FIG. 25C shows the waveform of a scan signal asserted on the write scan line WSL associated with the first one of the three adjacent power-supply lines DSL pertaining to the three-consecutive-row bundle. By the same token, the timing chart of FIG. 25D shows the waveform of a scan signal asserted on the write scan line WSL associated with the second one of the three adjacent power-supply lines DSL pertaining to the three-consecutive-row bundle. In the same way, the timing chart of FIG. 25E shows the waveform of a scan signal asserted on the write scan line WSL associated with the third one of the three adjacent power-supply lines DSL pertaining to the three-consecutive-row bundle.

As described above, by adoption of the driving method according to the third embodiment, even if each of the threshold-voltage compensation preparatory process and the threshold-voltage compensation process is carried out in a plurality of horizontal scan periods and even if a power-supply electric potential is asserted on a plurality of data-supply lines DSL pertaining to the same multi-consecutive-row bundle with common timings, the execution of each of the threshold-voltage compensation preparatory process and the threshold-voltage compensation process can be split among the horizontal scan periods.

Thus, the size of the screen of the organic EL display panel and the resolution of the screen can be increased.

### (E): Fourth Embodiment

### (E-1): System Configuration

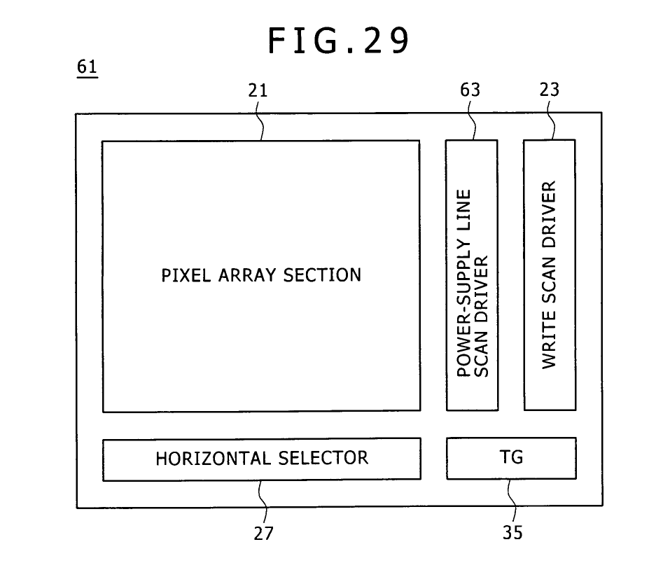

FIG. 29 is a block diagram showing a typical system configuration of an organic EL display panel 61 according to a fourth embodiment. In the block diagram of FIG. 29, configuration elements identical with their respective counterparts shown in the diagram of FIG. 19 are denoted by the same reference numerals as the counterparts.

The organic EL display panel 61 shown in the block diagram of FIG. 29 employs a pixel array section 21, a write scan driver 23, a power-supply line scan driver 63, a horizontal selector 27 and a timing generator 35. Each of the write scan driver 23, the power-supply line scan driver 63 and the horizontal selector 27 serves as a driving circuit.

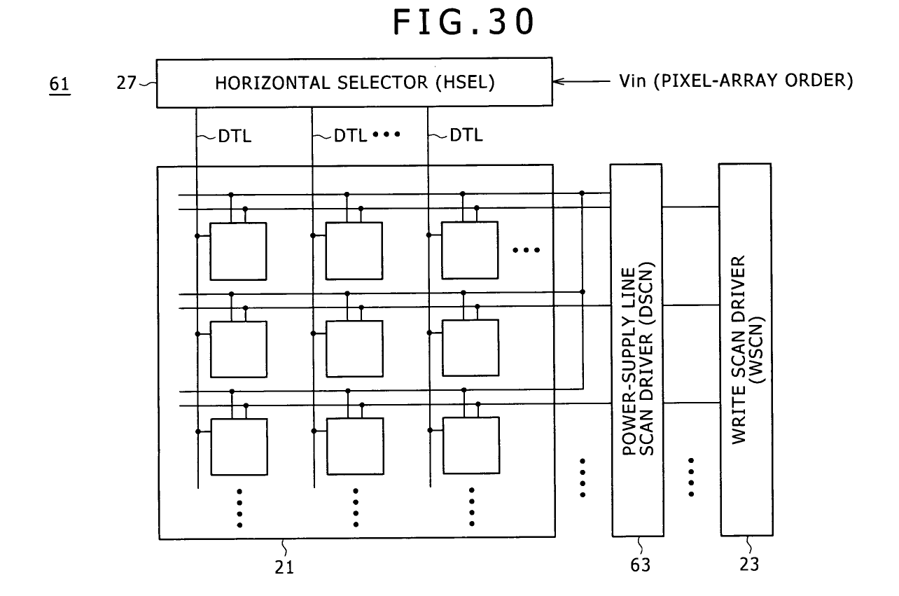

FIG. 30 is a block diagram showing connections between pixel circuits each serving as the circuit of a sub-pixel and the write scan driver 23, the power-supply line scan driver 63 as well as the horizontal selector 27 which are used for driving the pixel circuits. As shown in the block diagram of FIG. 30, also in the case of the fourth embodiment, it is assumed that three adjacent power-supply lines DSL each stretched in the horizontal direction are tied to each other at a junction point on one side of the pixel array section 21 to form a three-consecutive-row bundle, and the junction point is connected to the power-supply line scan driver 63.

In addition, in the case of the fourth embodiment, each of a threshold-voltage compensation preparatory process and a threshold-voltage compensation process, which are provided for a device driving transistor T2 connected to one of the three adjacent power-supply lines DSL, is carried out repeatedly in a plurality of horizontal scan periods each allocated to one of the three adjacent power-supply lines DSL.

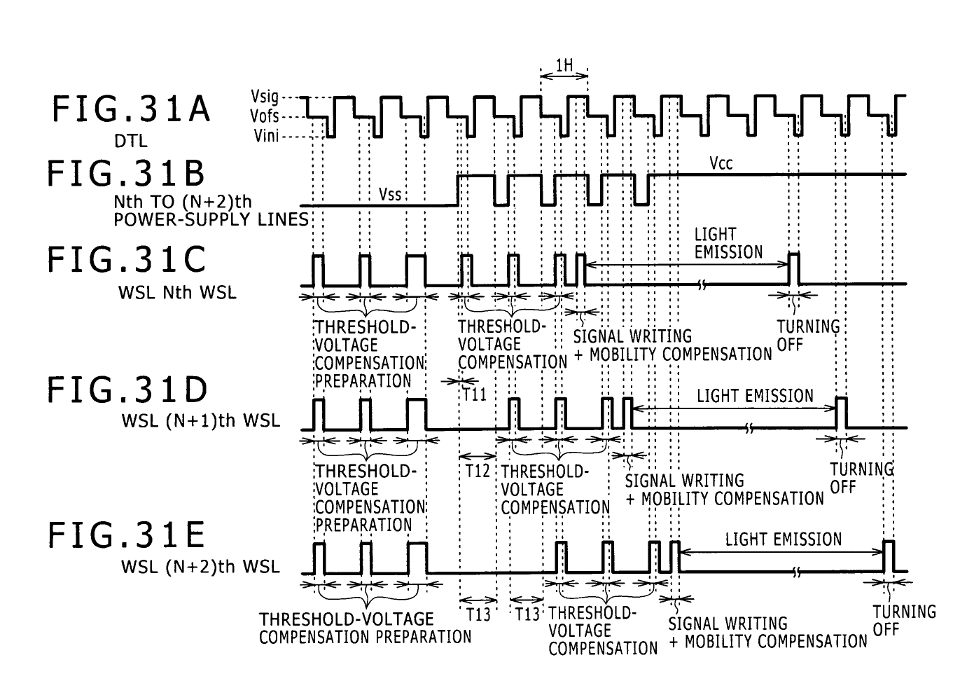

That is to say, basic conditions set for the fourth embodiment are basically the same as those of the third embodiment. The fourth embodiment is different from the third embodiment in that, in the case of the fourth embodiment, after the light emission process has been started for the write scan line WSL associated with the last one of the power-supply lines DSL pertaining to the three-consecutive-row bundle, the power-supply electric potential asserted on the power-supply line DSL to serve as a driving voltage is sustained at the high-level power-supply electric potential Vcc as it is as shown on the right-hand side of a timing chart of FIG. 31B.

### (E-2): Driving Operations and Effects

The timing diagram of FIGS. 31A to 31E includes a timing chart shown in FIG. 31B as a timing chart showing the waveform of the power-supply electric potential asserted on the power-supply line DSL to serve as a driving voltage in the fourth embodiment. Operations carried out during a threshold-voltage compensation process for any power-supply line DSL pertaining to the three-consecutive-row bundle are the same as those of the third embodiment.

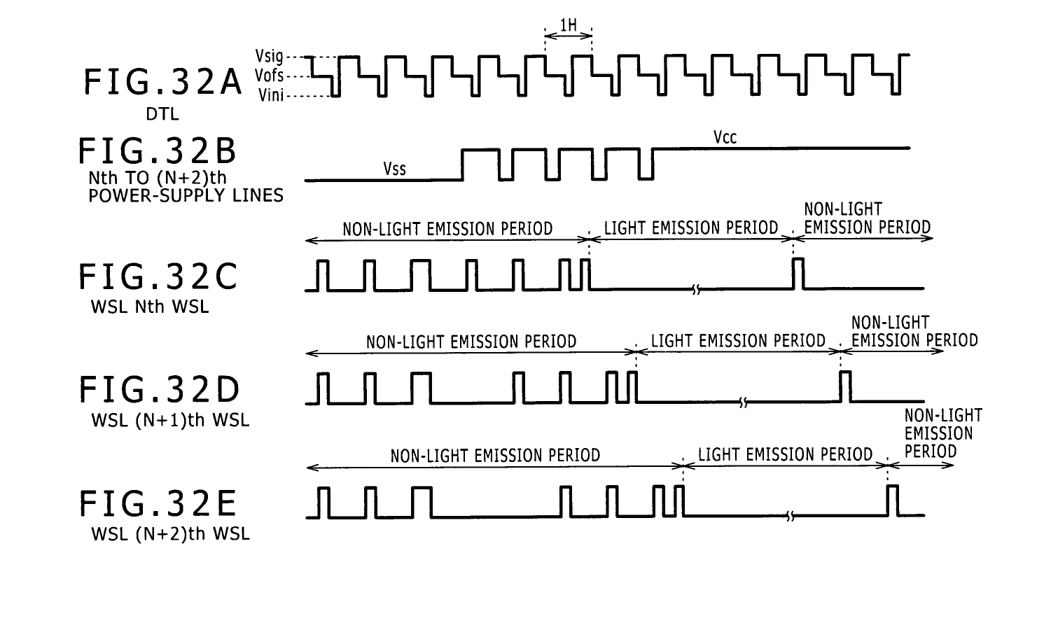

The fourth embodiment is different from the third embodiment in that, in the case of the fourth embodiment, the power-supply electric potential asserted on the power-supply line DSL to serve as a driving voltage is sustained at the high-level power-supply electric potential Vcc as it is till the light emission process has been completed for every write scan line WSL associated with one of the power-supply lines DSL pertaining to the three-consecutive-row bundle as shown in a timing chart of FIG. 32B. It is to be noted that, in a timing diagram of FIG. 32, elements identical with their respective counterparts shown in the timing diagram of FIGS. 25A to 25E are denoted by the same reference notations as the counterparts.

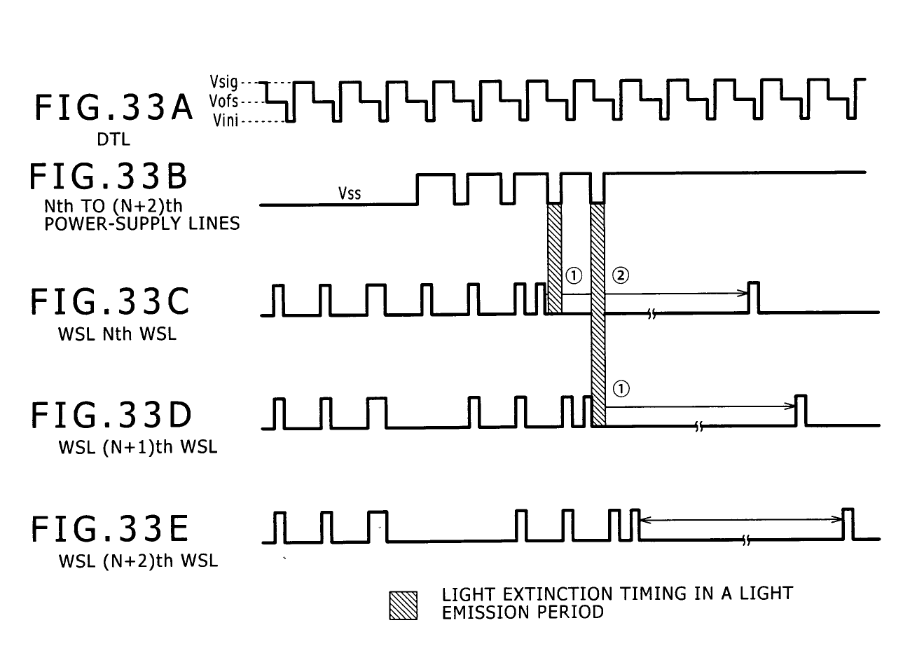

As shown in timing diagram of FIGS. 33A to 33E, the number of no-light emission periods included in a light emission period is 2 for the write scan line WSL associated with the first one of the three adjacent power-supply lines DSL pertaining to the three-consecutive-row bundle, 1 for the write scan line WSL associated with the second one of the three adjacent power-supply lines DSL pertaining to the three-consecutive-row bundle and 0 for the write scan line WSL associated with the third one of the three adjacent power-supply lines DSL pertaining to the three-consecutive-row bundle. Thus, there are differences in light emission period length between the three write scan lines WSL. If a luminance difference caused by the maximum value of the differences in light emission period length between the three write scan lines WSL can be made smaller than 1%, however, it is possible to prevent the display screen from showing visual abnormalities such as luminance unevenness and image cords. In the case of the fourth embodiment, the maximum value of the differences in light emission period length between the three write scan lines WSL is a difference caused by two no-light emission periods included in a light emission period for the write scan line WSL associated with the first one of the three adjacent power-supply lines DSL pertaining to the three-consecutive-row bundle.

### (F): Fifth Embodiment

### (F-1): System Configuration

The following description explains a typical configuration of an organic EL display panel 71 according to a fifth embodiment which is different from the first to fourth embodiments. To be more specific, the configuration of the pixel circuit employed in the organic EL display panel 71 is different from those of the first to fourth embodiments. The fifth embodiment is explained by putting emphasis on the difference in pixel-circuit configuration and a difference in driving method. That is to say, the following description explains merely the differences in pixel-circuit configuration and in driving method between the first and fifth embodiments. It is needless to say that the following explanation of the differences in pixel-circuit configuration and in driving method between the first and fifth embodiments of course holds true of the differences in pixel-circuit configuration and in driving method between the fifth embodiment and each of the second to fourth embodiments.

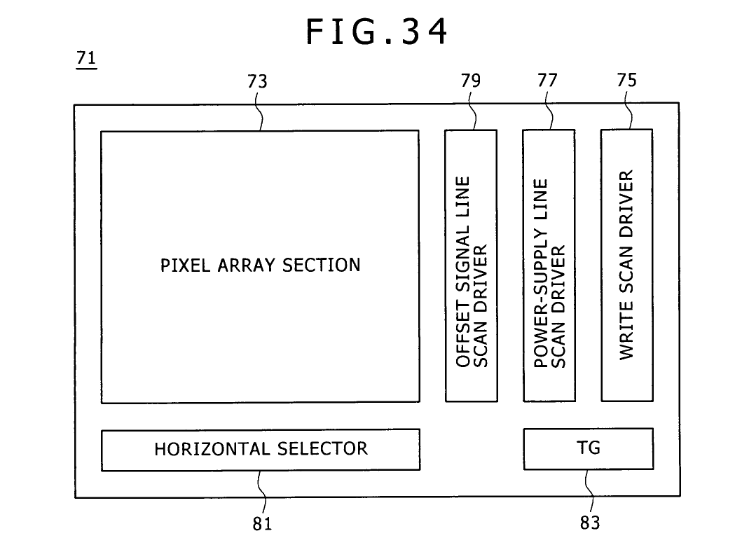

FIG. 34 is a block diagram showing a typical system configuration of the organic EL display panel 71 according to the fifth embodiment. The organic EL display panel 71 shown in the block diagram of FIG. 34 employs a pixel array section 73, a write scan driver 75, a power-supply line scan driver 77, an offset line scan driver 79, a horizontal selector 81 and a timing generator 83. Each of the write scan driver 75, the power-supply line scan driver 77 and the offset line scan driver 79 serves as a driving circuit.

The pixel array section 73 has a matrix structure which is a matrix of sub-pixel circuits each located at the intersection of one of signal lines DTL and one of write scan lines WSL. By the way, the sub-pixel circuit is the smallest unit of a pixel structure composing one pixel circuit. In general, one pixel circuit functioning as a white unit is configured to have three sub-pixel circuits, i.e., R, G and B sub-pixel circuits which are made of organic EL materials different from each other.

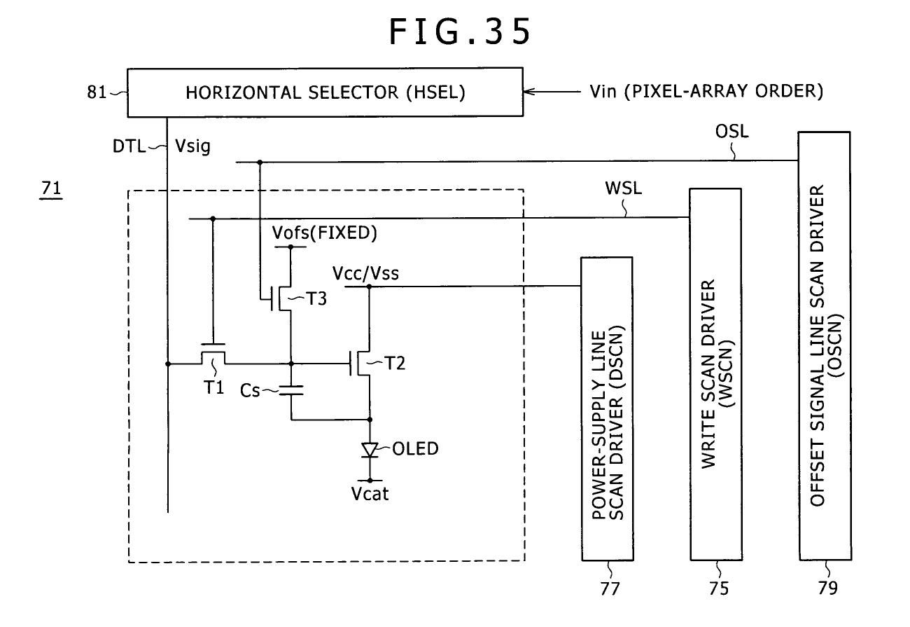

FIG. 35 is a diagram showing the internal configuration of a pixel circuit according to the fifth embodiment and driving circuits each used for driving the pixel circuit. The pixel circuit shown in the diagram of FIG. 35 is configured to include three thin-film transistors T1, T2 and T3 of the N-channel type, a signal holding capacitor Cs and an organic EL light emitting device OLED.

Also in the case of this circuit configuration, the write scan driver 75 controls the operations to put the first signal sampling transistor T1 in a turned-on state or a turned-off state through the write scan line WSL in order to control an operation to store the electric potential of a video signal Vsig asserted on the data signal line DTL into the signal holding capacitor Cs. In the case of the fifth embodiment, however, the video-signal electric potential Vsig is the only signal asserted by the horizontal selector 81 on the data signal line DTL. In addition, the write scan driver 75 is configured to have a shift register having as many output stages as desired to implement a vertical resolution of the displayed image.

The power-supply line scan driver 77 asserts a driving voltage having two different electric potentials on the power-supply line DSL connected to a specific one of two main electrodes of the device driving transistor T2 in order to control the operation of the pixel circuit in a manner of being interlocked with operations carried out by the other driving circuits. The operation of the pixel circuit includes not only a light emission process and no-light emission process of the organic EL light emitting device OLED, but also processes of compensating a drain-source current Ids generated by the device driving transistor T2 for variations of characteristics of the device driving transistor T2. To put it more concretely, the processes of compensating a drain-source current Ids generated by the device driving transistor T2 for variations of characteristics of the device driving transistor T2 are a process of compensating a drain-source current Ids generated by the device driving transistor T2 for variations of the threshold voltage of the device driving transistor T2 and a process of compensating a drain-source current Ids generated by the device driving transistor T2 for variations of the mobility of the device driving transistor T2. The processes of compensating a drain-source current Ids generated by the device driving transistor T2 for variations of characteristics of the device driving transistor T2 are carried out in order to avoid deteriorations of the uniformity of the displayed image.

In the case of this circuit configuration, the offset line scan driver 79 controls the operations to put the second signal sampling transistor T3 in a turned-on state or a turned-off state through an offset line OSL in order to control an operation to store the offset electric potential Vofs into the signal holding capacitor Cs. In the case of the fifth embodiment, however, the offset electric potential Vofs is the only electric potential that can be stored in the signal holding capacitor Cs by way of the second signal sampling transistor T3. In addition, the offset line scan driver 79 is configured to have a shift register having as many output stages as desired to implement a vertical resolution of the displayed image.

The horizontal selector 81 asserts the video-signal electric potential Vsig representing pixel data Vin on the data signal line DTL.

The offset line scan driver 79 is configured to have a shift register having as many output stages as desired to implement a horizontal resolution of the displayed image. The offset line scan driver 79 also employs a latch circuit provided for the output stages and a D/A converter provided for the latch circuit.

The timing generator 83 is a circuit device for generating timing pulses desired for driving the write scan line WSL, the power-supply line DSL, the offset line OSL and the data signal line DTL.

### (F-2): Typical Driving Operations

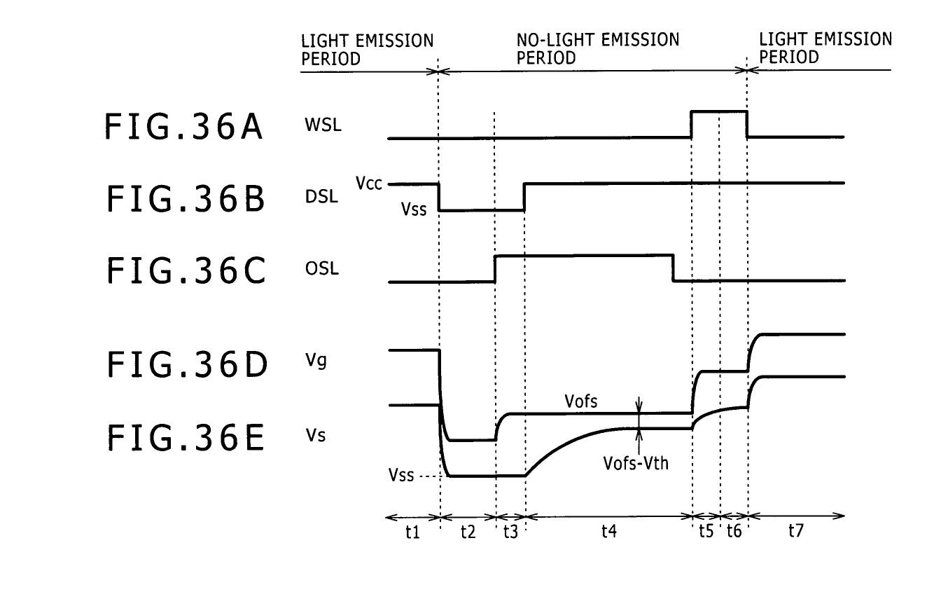

FIGS. 36A to 36E are a timing diagram referred to in description of typical driving operations carried out by the pixel circuit explained above by referring to the diagram of FIG. 35. By the way, the power-supply line scan driver 77 asserts two different power-supply electric potentials on the power-supply line DSL. The two different power-supply electric potentials asserted on the power-supply line DSL are the high-level power-supply electric potential Vcc for the light emission period and the low-level power-supply electric potential Vss for the no-light emission period.

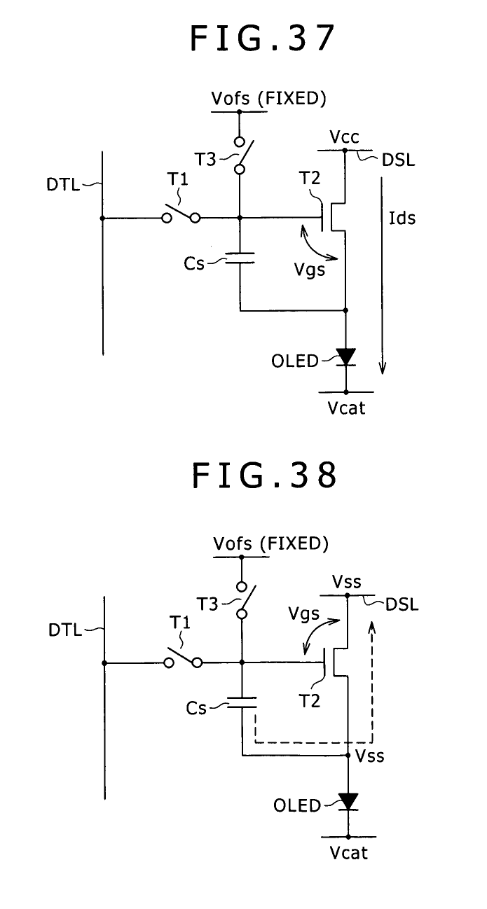

First of all, a driving operation of the pixel circuit in the light emission state during a period t1 shown in the timing diagram of FIGS. 36A to 36E is explained by referring to a circuit diagram of FIG. 37. In the light emission state, the first signal sampling transistor T1 is sustained in a turned-off state. On the other hand, the device driving transistor T2 is operating in the saturated region. In the operating state in the saturated region, a drain-source current Ids generated by the device driving transistor T2 according to the gate-source voltage Vgs appearing between the gate and source electrodes of the device driving transistor T2 is flowing through the device driving transistor T2.

Next, an operating state during a period t2 shown in the timing diagram of FIGS. 36A to 36E is explained. The period t2 is a portion of a no-light emission period. The period t2 of the no-light emission period is started when the power-supply electric potential asserted on the power-supply line DSL is changed from the high-level power-supply electric potential Vcc to the low-level power-supply electric potential Vss. If the low-level power-supply electric potential Vss is smaller than the sum of the threshold voltage Vthel of the organic EL light emitting device OLED and the cathode voltage Vcath, that is, if the relation Vss<(Vthel+Vcath) is satisfied, the organic EL light emitting device ceases to emit light.

It is to be noted that the source electric potential Vs appearing on the source electrode of the device driving transistor T2 is equal to the electric potential asserted on the power-supply line DSL. That is to say, the anode electrode of the organic EL light emitting device OLED is electrically charged to the low-level power-supply electric potential Vss. FIG. 38 is a circuit diagram showing the pixel circuit in an operating state during the period t2. As shown by a dashed line in the circuit diagram of FIG. 38, at that time, electric charge accumulated in the signal holding capacitor Cs is being withdrawn to the power-supply line DSL.

Then, when the electric potential asserted on the offset line OSL is changed by the offset line scan driver 79 to a high-level electric potential, the second signal sampling transistor T3 is put in a turned-on state, allowing the electric potential appearing on the gate electrode of the device driving transistor T2 to change to the offset electric potential Vofs at the beginning of a period t3 shown in the timing diagram of FIGS. 36A to 36E.

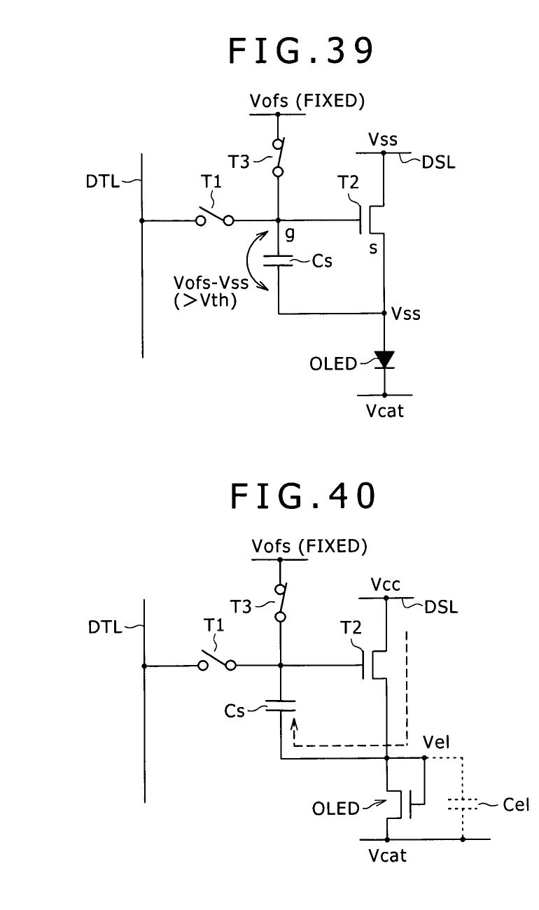

FIG. 39 is a circuit diagram showing the pixel circuit in an operating state during the period t3. In this operating state, the gate-source voltage Vgs appearing between the gate and source electrodes of the device driving transistor T2 is equal to a voltage difference (Vofs−Vss). The voltage difference (Vofs−Vss) is set at a magnitude greater than the threshold voltage Vth of the device driving transistor T2, that is, the voltage difference (Vofs−Vss) is set at such a magnitude that the relation (Vofs−Vss)>Vth is satisfied. This is because, if the magnitude of the voltage difference (Vofs−Vss) is not greater than the threshold voltage Vth of the device driving transistor T2, the threshold-voltage compensation process cited above may not be carried out.

Then, the electric potential asserted on the power-supply line DSL is changed from the low-level power-supply electric potential Vss to the high-level power-supply electric potential Vcc at the beginning of a period t4 shown in the timing diagram of FIGS. 36A to 36E. When the electric potential asserted on the power-supply line DSL is changed from the low-level power-supply electric potential Vss to the high-level power-supply electric potential Vcc, the electric potential Vs appearing on the source electrode of the device driving transistor T2 (that is, the electric potential appearing on the anode electrode of the organic EL light emitting device OLED) rises to the high-level power-supply electric potential Vcc.

FIG. 40 is a circuit diagram showing the pixel circuit in an operating state during the period t4. The circuit diagram of FIG. 40 also shows an equivalent circuit of the organic EL light emitting device OLED. The equivalent circuit of the organic EL light emitting device OLED has a diode representing the organic EL light emitting device OLED and a parasitic capacitor Cel of the organic EL light emitting device OLED. In this operating state, as long as the relation Vel<(Vcat+Vthel) is satisfied, the drain-source current Ids generated by the device driving transistor T2 is used for electrically charging the signal holding capacitor Cs and the parasitic capacitor Cel provided that a leak current flowing through the organic EL light emitting device OLED can be considered to be much smaller than the drain-source current Ids generated by the device driving transistor T2. Reference notation Vel used in the relation denotes an electric potential appearing on the anode electrode of the organic EL light emitting device OLED.

As a result, the anode electric potential Vel appearing on the anode electrode of the organic EL light emitting device OLED (that is, the source electric potential Vs appearing on the source electrode of the device driving transistor T2) rises with the lapse of time as shown in a timing chart of FIG. 36E during the period t4. That is to say, while the gate electric potential Vg appearing on the gate electrode of the device driving transistor T2 is being kept at the offset electric potential Vofs, the source electric potential Vs appearing on the source electrode of the device driving transistor T2 is rising. The operation to raise the source electric potential Vs appearing on the source electrode of the device driving transistor T2 during the period t4 is referred to as the threshold-voltage compensation process cited above.

In the course of time, the gate-source voltage Vgs appearing between the gate and source electrodes of the device driving transistor T2 is converged to the threshold voltage Vth of the device driving transistor T2. At that time, the source electric potential Vs appearing on the source electrode of the device driving transistor T2 is expressed by the following relations:

Vs=Vel=Vofs−Vth<Vcat+Vthel

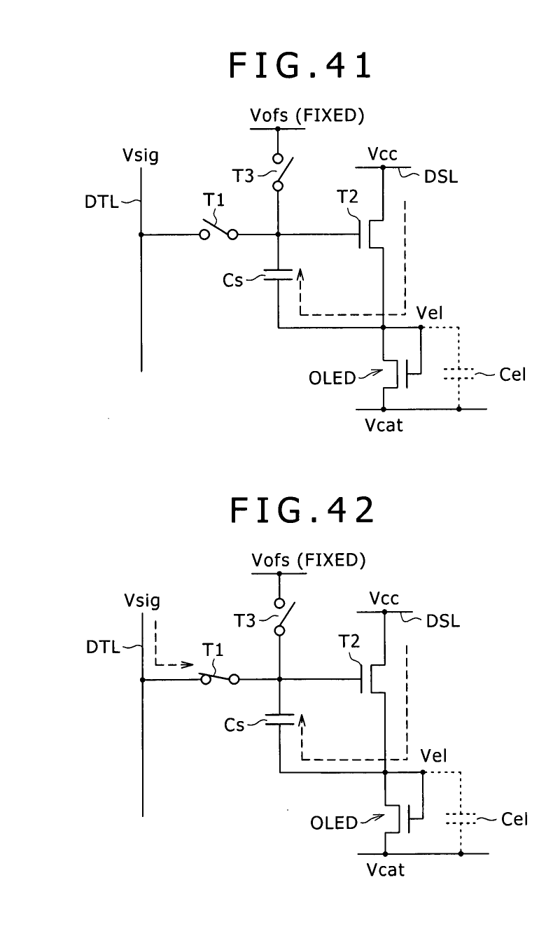

When the gate-source voltage Vgs appearing between the gate and source electrodes of the device driving transistor T2 attains the threshold voltage Vth of the device driving transistor T2, the threshold-voltage compensation process is ended and the second signal sampling transistor T3 is again put in a turned-off state at the end part of the period t4 shown in the timing diagram of FIGS. 36A to 36E. FIG. 41 is a circuit diagram showing the pixel circuit in an operating state during the end part of the period t4.

During the period t4, the electric potential asserted on data signal line DTL is changed to the video-signal electric potential Vsig. Then, at the beginning of a period t5 shown in the timing diagram of FIGS. 36A to 36E, that is, after a sufficient setup time for the video-signal electric potential Vsig has been established, the first signal sampling transistor T1 is again put in a turned-on state. FIG. 42 is a circuit diagram showing the pixel circuit in an operating state during the period t5 and a period t6 shown in the timing diagram of FIGS. 36A to 36E as a period immediately lagging behind the period t5. The video-signal electric potential Vsig is an electric potential representing the gradation of the pixel circuit.

Since the video-signal electric potential Vsig asserted on the data signal line DTL is supplied to the gate electrode of the device driving transistor T2, the gate electric potential Vg appearing on the gate electrode of the device driving transistor T2 is also rising from the offset electric potential Vofs to the video-signal electric potential Vsig during the period t5. Since a drain-source current Ids generated by the device driving transistor T2 is flowing from the power-supply line DSL to the signal holding capacitor Cs during the period t5, the source electric potential Vs appearing on the source electrode of the device driving transistor T2 is also rising with the lapse of time.

At that time, if the source electric potential Vs appearing on the source electrode of the device driving transistor T2 does not exceed the sum of the threshold voltage Vthel of the organic EL light emitting device OLED and the cathode voltage Vcat appearing on the cathode electrode of the organic EL light emitting device OLED, the drain-source current Ids generated by the device driving transistor T2 is used for electrically charging the signal holding capacitor Cs and the parasitic capacitor Cel provided that a leak current flowing through the organic EL light emitting device OLED can be considered to be much smaller than the drain-source current Ids generated by the device driving transistor T2.

It is to be noted that, since the threshold-voltage compensation process of the device driving transistor T2 has already been completed, the magnitude of the drain-source current Ids generated by the device driving transistor T2 reflects the mobility μ of the device driving transistor T2. To put it more concretely, the larger the mobility μ of the device driving transistor T2, the larger the magnitude of the drain-source current Ids generated by the device driving transistor T2 and the higher the speed at which the source electric potential Vs appearing on the source electrode of the device driving transistor T2 is rising. Conversely, the smaller the mobility μ of the device driving transistor T2, the smaller the magnitude of the drain-source current Ids generated by the device driving transistor T2 and the lower the speed at which the source electric potential Vs appearing on the source electrode of the device driving transistor T2 is rising.

As a result, the voltage stored in the signal holding capacitor Cs is compensated for variations in mobility μ. That is to say, the gate-source voltage Vgs appearing between the gate and source electrodes of the device driving transistor T2 is corrected to a value determined in accordance with the mobility μ. To put it more concretely, the gate-source voltage Vgs appearing between the gate and source electrodes of the device driving transistor T2 is corrected to a relatively large value for a device driving transistor T2 having a relatively small mobility μ or a relatively small value for a device driving transistor T2 having a relatively large mobility μ. The operation to correct the gate-source voltage Vgs appearing between the gate and source electrodes of the device driving transistor T2 to a value determined in accordance with the mobility μ is referred to as a mobility compensation process which is carried out during the periods t5 and t6 shown in the timing diagram of FIGS. 36A to 36E. It is to be noted that, during the periods t5 and t6, a signal writing process of storing the electric potential of a video signal Vsig into the signal holding capacitor Cs is also carried out as well.

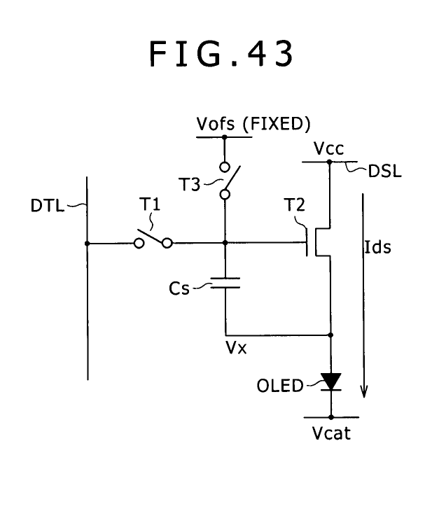

Finally, the first signal sampling transistor T1 is put in a turned-off state at the beginning of a period t7 shown in the timing diagram of FIGS. 36A to 36E in order to end the signal writing process of storing the electric potential of a video signal Vsig into the signal holding capacitor Cs and start the next light emission period of the organic EL light emitting device OLED. FIG. 43 is a circuit diagram showing the pixel circuit in an operating state during the period t7. It is to be noted that, in the light emission period, the gate-source voltage Vgs appearing between the gate and source electrodes of the device driving transistor T2 is held at a fixed magnitude by a coupling effect of the signal holding capacitor Cs. Thus, in this light emission period, the device driving transistor T2 is outputting a constant drain-source current Ids generated by the device driving transistor T2 to the organic EL light emitting device OLED.

In this light emission period, the source electric potential Vs appearing on the source electrode of the device driving transistor T2 and the anode electric potential Vel appearing on the anode electrode of the organic EL light emitting device OLED are rising to an electric potential Vx which allows the drain-source current Ids generated by the device driving transistor T2 to flow through the organic EL light emitting device OLED, starting the light emission state of the organic EL light emitting device OLED. In the light emission state, the organic EL light emitting device OLED is emitting light.

By the way, even in the case of the pixel circuit according to the fifth embodiment, the I-V characteristic of the organic EL light emitting device OLED also changes due to the so-called time aging phenomenon.

The source electric potential Vs appearing on the source electrode of the device driving transistor T2 also changes due to the variation of the I-V characteristic of the organic EL light emitting device OLED. Since the gate-source voltage Vgs appearing between the gate and source electrodes of the device driving transistor T2 is held at a fixed magnitude by a coupling effect of the signal holding capacitor Cs, however, the drain-source current Ids generated by the device driving transistor T2 as a current to flow to the organic EL light emitting device OLED does not change either. By making use of the pixel circuit according to the fifth embodiment and adopting a driving method provided for the pixel circuit as described above, the drain-source current Ids generated by the device driving transistor T2 as a current to flow to the organic EL light emitting device OLED can be sustained as at a constant magnitude determined by the gate-source voltage Vgs appearing between the gate and source electrodes of the device driving transistor T2 in spite of the fact that the I-V characteristic of the organic EL light emitting device OLED also changes due to the so-called time aging phenomenon. Thus, the luminance of light emitted by the organic EL light emitting device OLED can be sustained at a magnitude determined by the video-signal electric potential Vsig.

### (F-3): Conclusion

As described above, also in the case of the fifth embodiment employing three thin-film transistors in the pixel circuit, the same driving operations as the other embodiments can be carried out. In particular, by combining the wiring structures of the second to fourth embodiments and the driving methods of the second to fourth embodiments, it is possible to implement an organic EL display panel which can be produced at a low manufacturing cost.

### (G): Other Embodiments

### (G-1): Wiring Structure

In the embodiments described above, three adjacent power-supply lines DSL are tied to each other to form a three-consecutive-row bundle to which a common power-supply electric potential serving as a driving voltage is applied. However, the number of adjacent power-supply lines DSL tied to each other to form a multi-consecutive-row bundle can be 2, 4 or an integer greater than 4. In addition, the common power-supply electric potential serving as a driving voltage can be made common to all power-supply lines DSL.

### (G-2): Product Examples

### (a): Electronic Instruments

The present invention has been exemplified by taking an organic EL display panel as an example. It is to be noted that the organic EL display panel is also traded in the form of a commercial product employed in a variety of electronic instruments. The following description explains typical implementations of the organic EL display panel in the electronic instruments.

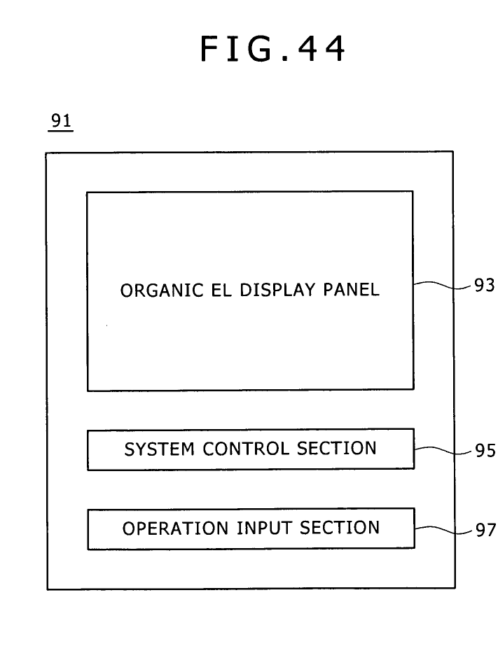

FIG. 44 is a conceptual block diagram showing an electronic instrument 91. As shown in the figure, the electronic instrument 91 has the organic EL display panel 93 described above, a system control section 95 and an operation input section 97. The substance of processing carried out by the system control section 95 is dependent on what product the electronic instrument 91 functions as. The operation input section 97 is a device for supplying an operation input entered by the user to the system control section 95. The operation input section 97 is typically a graphic interface and/or a mechanical interface such as switches and buttons.

It is to be noted that the electronic instrument 91 is by no means limited to an apparatus used in a specific field. That is to say, the electronic instrument 91 can be an apparatus used in any field as long as the apparatus is provided with a function for displaying a video signal supplied thereto or generated therein as an image or a video.

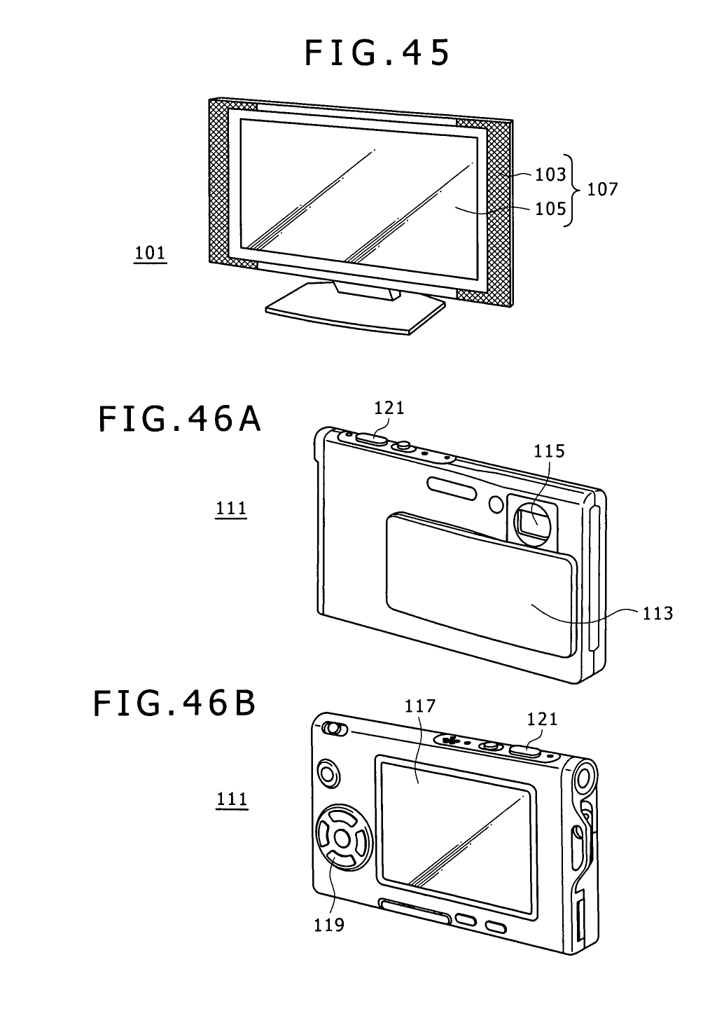

FIG. 45 is a diagram showing a squint view of the external appearance of a TV set 101 serving as an electronic instrument 91 employing the organic EL display panel 93 to which the embodiments of the present invention are applied. The TV set 101 serving as a typical implementation of the electronic instrument 91 to which the embodiments of the present invention are applied employs a video display screen section 107 which typically includes a front panel 103 and a filter glass plate 105. The TV set 101 is constructed by employing the organic EL display panel provided by the embodiments of the present invention in the TV set 101 as the video display screen section 107.

The electronic instrument 91 can also be a digital camera 111. FIGS. 46A and 46B are diagrams each showing a squint views of the external appearance of the digital camera 111 to which the embodiments of the present invention are applied. To be more specific, FIG. 46A is a diagram showing a squint view of the external appearance of the digital camera 111 seen from a position on the front side of the digital camera 111 whereas FIG. 46B is a diagram showing a squint view of the external appearance of the digital camera 111 seen from a position on the rear side of the digital camera 111.

The digital camera 111 serving as a typical implementation of the electronic instrument 91 to which the embodiments of the present invention are applied employs a protection cover 113, an image taking lens 115, a display section 117, a control switch 119 and a shutter button 121. The digital camera 111 is constructed by employing the organic EL display panel 93 provided by the embodiments of the present invention in the digital camera as the display section 117.

The electronic instrument 91 can also be a video camera 131.

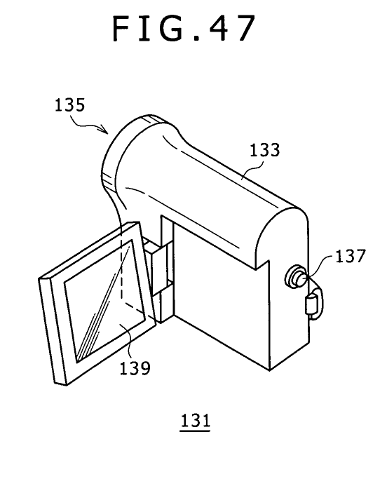

FIG. 47 is a diagram showing a squint view of the external appearance of the video camera 131 to which the embodiments of the present invention are applied. The video camera 131 serving as a typical implementation of the electronic instrument 91 to which the embodiments of the present invention are applied employs a main body 133, an image taking lens 135 for taking an image, a start/stop switch 137 and a display section 139. Provided on the front face of the video camera 131, the image-taking lens 135 oriented in the forward direction is a lens for taking an image of a photographing subject located in front of the main body 133. The start/stop switch 137 is a switch to be operated by the user to start or stop a photographing operation. The video camera 131 is constructed by employing the organic EL display panel 93 provided by the embodiments of the present invention in the video camera as the display section 139.

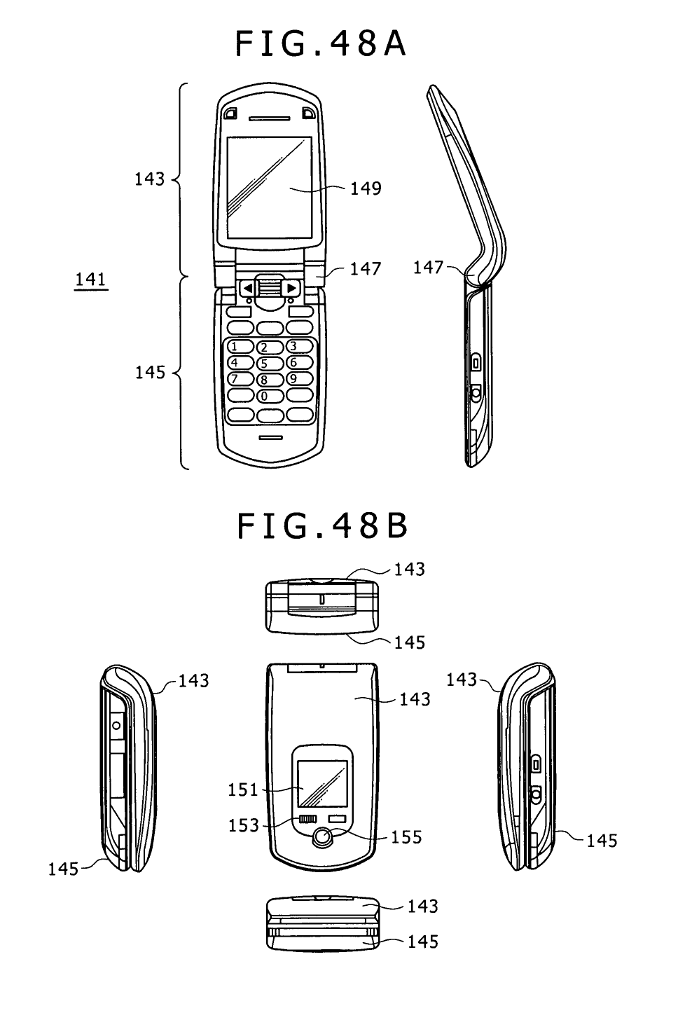

The electronic instrument 91 can also be a cellular phone 141. FIGS. 48A and 48B are diagrams each showing the external appearance of a portable terminal such as the cellular phone 141 to which the embodiments of the present invention are applied. To be more specific, FIG. 48A is a diagram showing the front view of the cellular phone 141 in a state of being already opened and a diagram showing a side of the cellular phone 141 in a state of being already opened. FIG. 48B is a diagram showing the front view of the cellular phone 141 in a state of being already closed, a diagram showing the left side of the cellular phone 141 in a state of being already closed, a diagram showing the right side of the cellular phone 141 in a state of being already closed, a diagram showing the top view of the cellular phone 141 in a state of being already closed and a diagram showing the bottom view of the cellular phone 141 in a state of being already closed.

The cellular phone 141 serving as a typical implementation of the electronic instrument 91 to which the embodiments of the present invention are applied employs an upper case 143, a lower case 145, a link section 147 which is a hinge, a display section 149, a display sub-section 151, a picture light 153 and an image taking lens 155. The cellular phone 141 is constructed by employing the organic EL display panel 93 provided by the embodiments of the present invention in the cellular phone 141 as the display section 149 and/or the display sub-section 151.

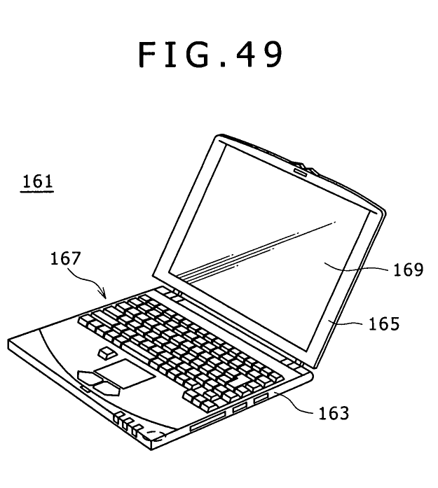

The electronic instrument 91 can also be a computer. FIG. 49 is a diagram showing a squint view of the external appearance of a notebook personal computer 161 to which the embodiments of the present invention are applied. The notebook personal computer 161 serving as a typical implementation of the electronic instrument 91 to which the embodiments of the present invention are applied employs a lower case 163, an upper case 165 and a keyboard 167 to be operated by the user for entering characters and a display section 169 for displaying an image. The notebook personal computer 161 is constructed by employing the organic EL display panel 93 provided by the embodiments of the present invention in the personal computer 161 as the display section 169.

In addition, the electronic instrument 91 can also be an audio reproduction apparatus, a game machine, an electronic book and an electronic dictionary to mention a few.

### (G-3) Other Typical Display Devices

Each of the embodiments described above applies the present invention to an organic EL display panel 93. However, the driving technologies described above can also be applied to other organic EL display devices. For example, the embodiments of the present invention can also be applied to a display apparatus employing a display screen having a matrix/array of light emitting devices of other types. Typical light emitting devices of the other types are an LED (Light Emitting Diode) and a light emitting device having another diode structure. As another example, the embodiments of the present invention can also be applied to an inorganic EL display panel.

### (G-4): Others

The embodiments described above can conceivably be changed to a variety of modified versions within a range of essentials of the present invention. In addition, it is also possible to conceive a variety of modified versions obtained as a result of creation and/or combination of what are described in the invention specification.

On top of that, it should be understood by those skilled in the art that a variety of modifications, combinations, sub-combinations and alterations may occur, depending on design requirements and other factors as far as they are within the scope of the appended claims or the equivalents thereof.

The present application contains subject matter related to that disclosed in Japanese Priority Patent Application JP 2008-121741 filed in the Japan Patent Office on May 8, 2008, the entire content of which is hereby incorporated by reference.

What is claimed is:

1. An organic electro luminescence display panel:
provided with a pixel structure and a wiring structure which are adapted to an active matrix driving method; and
driven by an electric potential asserted on each multi-consecutive-row bundle composed of adjacent power-supply lines, which are electrically tied to each other, each stretched in a horizontal direction and each used for supplying a driving current to an organic electro luminescence light emitting device employed in every pixel circuit of said organic electro luminescence display panel, to serve as an electric potential having two or more different magnitudes.

2. The organic electro luminescence display panel according to claim 1, said organic electro luminescence display panel including a power-supply line driving circuit lowering a power-supply electric potential appearing on a plurality of said power-supply lines tied to each other to form said multi-consecutive-row bundle from a light emission electric potential to a light extinction electric potential at least once during a time period, which exists between a rise of said power-supply electric potential from said light extinction electric potential to said light emission electric potential for the first time in a no-light emission period and the start of a light emission period of a power-supply line stretched in said horizontal direction to serve as the last power-supply line pertaining to said multi-consecutive-row bundle as a time period in a light emission cycle composed of said light emission period and said no-light emission period.

3. The organic electro luminescence display panel according to claim 2 wherein said light emission cycle is one horizontal scan period.

4. The organic electro luminescence display panel according to claim 1 wherein, during a no-light emission period for any power-supply line stretched in said horizontal direction to serve as a power-supply line pertaining to said multi-consecutive-row bundle, at least three electric potentials, i.e., the electric potential of a video signal, a reference electric potential for compensation for threshold-voltage variations of a device driving transistor for controlling the magnitude of a driving current flowing to an organic electro luminescence light emitting device employed in the same pixel circuit as said device driving transistor and an initially stored electric potential, are supplied to the gate electrode of said device driving transistor.

5. The organic electro luminescence display panel according to claim 4 wherein said initially stored electric potential is set so that:
the level of said initially stored electric potential is lower than the level of said reference electric potential for compensation for said threshold-voltage variations; and
the difference between said level of said initially stored electric potential and the level of said light extinction electric potential is not greater than the threshold voltage of said device driving transistor.

6. The organic electro luminescence display panel according to claim 1 wherein, if a threshold-value compensation process is carried out by dividing said threshold-value compensation process into a plurality of threshold-value compensation sub-processes each carried out in a horizontal scan period, said initially stored electric potential is supplied to the gate electrode of said device driving transistor for controlling the magnitude of a driving current flowing to an organic electro luminescence light emitting device employed in same pixel circuit as said device driving transistor at least during all said threshold-value compensation sub-processes except said last threshold-value compensation sub-process immediately leading ahead of a signal writing process of supplying said electric potential of a video signal to said gate electrode of said device driving transistor.

7. The organic electro luminescence display panel according to claim 4 wherein said initially stored electric potential is supplied to the gate electrode of said device driving transistor at least with the timing of a last threshold-value compensation preparatory period common to all said power-supply lines stretched in said horizontal direction and tied to each other to form a multi-consecutive row bundle.

8. The organic electro luminescence display panel according to claim 2 wherein said power-supply line driving circuit provides an electric-potential lowering period to lower said power-supply electric potential appearing on a plurality of said power-supply lines tied to each other to form said multi-consecutive-row bundle from said light emission electric potential to said light extinction electric potential once for each of said power-supply lines tied to each other to form said multi-consecutive-row bundle between the start of a light emission period for said first power-supply line pertaining to said multi-consecutive row bundle and the end of a light emission period for said last power-supply line pertaining to said multi-consecutive row bundle.

9. The organic electro luminescence display panel according to claim 1, said organic electro luminescence display panel including a power-supply line driving circuit which lowers said power-supply electric potential appearing on a plurality of power-supply lines tied to each other to form said multi-consecutive-row bundle from said light emission electric potential to said light extinction electric potential at least once during a time period existing between the start of a threshold-voltage compensation period of a power-supply line stretched in said horizontal direction to serve as the first power-supply line of said multi-consecutive-row bundle and the end of a threshold-voltage compensation period of a power-supply line stretched in said horizontal direction to serve as the last power-supply line of said multi-consecutive-row bundle as a time period in a light emission cycle composed of a light emission period and a no-light emission period.

10. An electronic instrument comprising:
an organic electro luminescence display panel provided with a pixel structure adapted to an active matrix driving method; and
driven by an electric potential asserted by a power-supply line driving circuit on each multi-consecutive-row bundle composed of adjacent power-supply lines, which are electrically tied to each other and each used for supplying a driving current to an organic electro luminescence light emitting device employed in every pixel circuit of said organic electro luminescence display panel, to serve as an electric potential having two or more different magnitudes;
a system control section configured to control operations of the entire system of said electronic instrument; and
an operation input section configured to receive operation inputs entered to said system control section.

11. A driving method for driving an organic electro luminescence display panel having a pixel structure and a wiring structure which are provided for an active matrix driving method whereby said organic electro luminescence display panel is driven by an electric potential asserted on each multi-consecutive-row bundle composed of adjacent power-supply lines, which are electrically tied to each other and each used for supplying a driving current to an organic electro luminescence light emitting device employed in every pixel circuit of said organic electro luminescence display panel, to serve as an electric potential having two or more different magnitudes.
